(19) United States
(12) Patent Application Publication
(10) Pub. No.: US 2025/0367610 A1
(43) Pub. Date: Dec. 4, 2025

(54) Block Copolymers Grafted to Porous Polymeric Substrate

(71) Applicant: Solventum Intellectual Properties Company, Maplewood, MN (US)

(72) Inventors: Andrew Weston Vail, Bayport, MN (US); Jerald K Rasmussen, Woodville, MN (US); Narendranath Bhokisham, Saint Paul, MN (US)

(21) Appl. No.: 18/878,040

(22) PCT Filed: May 10, 2023
(86) PCT No.: PCT/IB2023/054840

§ 371 Date: Dec. 21, 2024

Related U.S. Application Data
(60) Provisional application No. 63/366,868, filed on Jun. 23, 2022.
(60) Provisional application No. 63/496,568, filed on Apr. 17, 2023.

(51) Int. Cl. B01D 71/52; B01D 67/00; B01D 71/78; B01D 71/80

(52) U.S. Cl. CPC B01D 71/52; B01D 67/0093; B01D 71/78; B01D 71/80; B01D 2323/30; B01D 2323/385; B01D 2325/14; B01D 2325/16

(57) ABSTRACT

A separation article is provided that is useful for separation of complex samples that contain materials having different sizes and optionally having different ionic groups. The separation articles include a plurality of block copolymers grafted to a solid polymeric substrate using a reversible deactivation radical polymerization process. The block copolymers extend away from a surface of the solid porous polymeric substrate. The block has an outer block (i.e., second polymeric block) that provides size or steric exclusion and an inner block (i.e., first block) with acidic groups or salts thereof, basic groups or salts thereof, or combinations thereof that can bind with compounds having a complementary group and that are sufficiently small to pass through the size or steric exclusion second polymeric block. The separation articles can be used, for example, for separation of biomaterials in a sample.

### SUMMARY

A separation article, a method of making the separation article, and a method of separating various materials (e.g., biomaterials) are provided. The separation article includes a block copolymer grafted to a porous polymeric substrate that is a solid. The block copolymer has a second polymeric block that provides size exclusion and a first polymeric block that can bind to acidic or basic groups on biomaterials that are not excluded by the second polymeric block.

In a first aspect, a separation article is provided that includes (1) a porous polymeric substrate that is a solid and (2) a plurality of block copolymeric chains grafted to the solid porous polymeric substrate and extending away from a surface of the solid porous polymeric substrate. The block copolymeric chains comprise (a) a first polymeric block that is covalently attached to the porous polymeric substrate and (b) a second polymeric block that is covalently bonded to the first polymeric block with the first polymeric block positioned between the second polymeric block and the porous polymeric substrate. The first polymeric block comprises a first monomeric unit that is an acidic monomeric unit comprising an acidic group or a salt thereof, a basic monomeric unit comprising a basic group or a salt thereof, or a combination thereof. The second polymeric block comprises a polyether-containing monomeric unit.

In a second aspect, a method of making a separation article is provided. The separation article comprises a porous polymeric substrate that is a solid and a plurality of block copolymers grafted to the porous polymeric substrate and extending away from a surface of the porous polymeric substrate. The method includes providing the porous polymeric substrate and grafting a plurality of first polymeric blocks to the porous polymeric substrate using a reversible deactivation radical polymerization process, wherein the first polymeric blocks are covalently bonded to the porous polymeric substrate. The first polymeric blocks are a reaction product of a first polymerizable composition comprising 1) an acidic monomer comprising an ethylenically unsaturated group and an acid group or salt thereof, 2) a basic monomer comprising an ethylenically unsaturated group and a basic group or salt thereof, or 3) a combination thereof. The method further includes forming a plurality of second polymeric blocks using the reversible deactivation radical polymerization process, wherein the second polymeric blocks are covalently bonded to the first polymeric blocks and wherein the first polymeric blocks are positioned between the porous polymeric substrate and the second polymeric blocks. The second polymeric blocks are a reaction product of a second polymerizable composition comprising a polyether-containing monomer comprising at least one ethylenically unsaturated group and a polyether group.

In a third aspect, a method of separation of a mixture of materials having different size and optionally different ionic charge is provided. The method includes preparing or providing a separation article comprising a porous polymeric substrate that is a solid and a plurality of block copolymers grafted to the porous polymeric substrate using a reversible deactivation radical polymerization process, wherein the block copolymers extend away from a surface of the porous polymeric substrate. The block copolymers comprise 1) a first polymeric block covalently attached to the solid porous polymeric substate and 2) a second polymeric block covalently bonded to the first polymeric block with the first polymeric block positioned between the second polymeric block and the porous polymeric substrate. The first polymeric block comprises first monomeric units having a binding group that is an acid group or a salt thereof, a basic group or a salt thereof, or a combination thereof for interacting with a material having a complementary group. The second polymeric block comprises polyether-containing monomeric units. The method further includes passing the mixture of materials through the separation article, wherein the second polymeric block separates the mixture of materials based on size or steric exclusion and allows only a portion of the materials to contact the acid groups, basic groups, or salts thereof of the first polymeric block.

### DETAILED DESCRIPTION

A separation article is provided that is useful for separation of complex samples that contain a mixture of materials having different sizes and optionally different ionic charges. The separation articles include a plurality of block copolymers grafted to a porous polymeric substrate that is a solid using a reversible deactivation radical polymerization process. The block copolymers extend away from a surface of the porous polymeric substrate. The block copolymers have an outer polymeric block (i.e., second polymeric block) that provides size or steric exclusion and an inner polymeric block (i.e., first polymeric block) with acidic groups or salts thereof, basic groups or salts thereof, or combinations thereof that can bind with materials having a complementary group and that are sufficiently small to pass through the size or steric exclusion second polymeric block. The separation articles can be used, for example, for separation of biomaterials in a sample.

As used herein, the terms “a”, “an”, “the”, and “at least one” are used interchangeably.

The term “and/or” means either or both. For example, “A and/or B” means A alone, B alone, or both A and B.

The term “alkyl” refers to a monovalent group that is a radical of an alkane. The alkyl group can have 1 to 32 carbon atoms, 1 to 20 carbon atoms, 1 to 12 carbon atoms, 1 to 10 carbon atoms, 1 to 6 carbon atoms, or 1 to 4 carbon atoms. The alkyl can be linear, branched, cyclic, or a combination thereof. A linear alkyl has at least one carbon atom while a cyclic alkyl has at least 3 carbon atoms and a branched alkyl has at least 2 carbon atoms.

The term “alkylene” refers to a divalent group that is a radical of an alkane. The alkylene group can have 1 to 32 carbon atoms, 1 to 20 carbon atoms, 1 to 12 carbon atoms, 1 to 10 carbon atoms, 1 to 6 carbon atoms, or 1 to 4 carbon atoms. The alkylene can be linear, branched, cyclic, or a combination thereof. A linear alkylene has at least one carbon atom while a cyclic alkylene has at least 3 carbon atoms and a branched alkylene has at least 2 carbon atoms.

The term “alkoxy” refers to a monovalent group of formula —OR^{a} where R^{a} is an alkyl as defined above.

The term “alkenyl” refers to a monovalent group that is a radical of an alkene, which is a hydrocarbon compound having at least one carbon-carbon double bond. In some embodiments, the alkenyl has a single carbon-carbon double bond. In some more specific embodiments, the alkenyl has an ethylenically unsaturated group (the carbon-carbon double bond is between the last two carbon atoms in a chain). The alkenyl can be linear, branched, or cyclic. The alkenyl often has at least 2, at least 3, at least 4, or at least 5 carbon atoms and can have up to 32 carbon atoms, up to 24 carbon atoms, up to 20 carbon atoms, up to 12 carbon atoms, up to 10 carbon atoms, or up to 5 carbon atoms.

The term “alkenyloxy” refers to a monovalent group of formula —OR^{b} where R^{b} is an alkenyl as defined above.

The term “aryl” refers to a monovalent group that is a radical of an aromatic carbocyclic compound. The aryl group has at least one aromatic carbocyclic ring and can have 1 to 3 optional rings that are connected to or fused to the aromatic carbocyclic ring. The additional rings can be aromatic, aliphatic, or a combination thereof. The aryl group usually has 5 to 20 carbon atoms or 6 to 10 carbon atoms.

The term “arylene” refers to a divalent group that is a radical of an aromatic carbocyclic compound. The arylene group has at least one aromatic carbocyclic ring and can have 1 to 3 optional rings that are connected to or fused to the aromatic carbocyclic ring. The additional rings can be aromatic, aliphatic, or a combination thereof. The arylene group usually has 5 to 20 carbon atoms or 6 to 10 carbon atoms.

The term “aralkyl” refers to an alkyl group substituted with at least one aryl group. That is, the aralkyl group is of formula —R^{d}-Ar where R^{d} is an alkylene and Ar is an aryl as defined above.

The aralkyl group contains 6 to 40 carbon atoms. The aralkyl group often contains an alkylene group having 1 to 20 carbon atoms or 1 to 10 carbon atoms and an aryl group having 5 to 20 carbon atoms or 6 to 10 carbon atoms.

The term “aralkylene” refers to an alkylene group substituted with at least one aryl group.

The term “aralkyloxy” refers to a monovalent group that is of formula —O—R^{d}-Ar with R^{d} and Ar being the same as defined above for aralkyl.

The term “alkaryl” refers to an aryl group substituted with at least one alkyl group. That is, the alkaryl group is of formula -Ar¹—R^{a} where Ar¹ is an arylene and R^{a} is an alkyl. The alkaryl group contains 6 to 40 carbon atoms. The alkaryl group often contain an arylene group having 5 to 20 carbon atoms or 6 to 10 carbon atoms and an alkyl group having 1 to 20 carbon atoms or 1 to 10 carbon atoms.

The terms “boronic acid group” and “boronato” are used interchangeably to refer to a group of formula —B(OH)₂. The boronic acid group can be present in the form of a salt having cationic counter ions.

The terms “carboxylic acid group” and “carboxy” are used interchangeably to refer to a group of formula —C(═O)—OH. The carboxylic acid group can be present in the form of a salt having cationic counter ions.

The term “iniferter” is used to refer to a group that can, under appropriate conditions, function as a free radical initiator, as a chain transfer agent, or as a free radical chain terminator. An iniferter that is activated by UV radiation can be referred to as a “photoiniferter”. The iniferters described herein are typically suitable for use with reversible addition-fragmentation chain transfer (RAFT) polymerization processes and may be referred to as a RAFT agent.

The term “hydrocarbyl” refers to a monovalent radical of a hydrocarbon. The hydrocarbyl can be saturated, partially unsaturated, or unsaturated and can have up to 20 carbon atoms, up to 10 carbon atoms, up to 6 carbon atoms, or up to 4 carbon atoms. It often has at least 1 carbon atom or at least 2 carbon atoms. The hydrocarbyl is often an alkyl, aryl, aralkyl, or alkaryl.

The term “hydrocarbylene” refers to a divalent radical of a hydrocarbon. The hydrocarbylene can be saturated, partially unsaturated, or unsaturated and can have up to 40 carbon atoms, up to 20 carbon atoms, up to 10 carbon atoms, up to 6 carbon atoms, or up to 4 carbon atoms. It often has at least 1 carbon atom or at least 2 carbon atoms. The hydrocarbyl is often an alkylene, arylene, aralkylene, or alkarylene.

The term “catenated atom” refers to an in-chain atom (rather than an atom of a chain substituent).

The term “catenated heteroatom” means a heteroatom replaces one or more carbon atoms in a carbon chain. The heteroatom is typically oxygen, sulfur, or nitrogen.

The term “fluid” refers to a liquid and/or gas.

The term “graft density” refers to the millimoles of monomeric units per gram grafted to a substrate. The millimoles are calculated by dividing the mass gain by the molecular weight of the monomer and multiplying by 1000. This value is then normalized by dividing by the original mass of the substrate (grams). The graft density is expressed as millimoles of monomeric units grafted per gram of substrate (mmoles/gram). For clarity, the material that is grafted is typically a polymeric material containing a plurality of monomeric units.

The term “heteroatom” means an atom other than carbon or hydrogen. The heteroatom is typically sulfur, nitrogen, or oxygen.

The term “heterohydrocarbyl” refers to a hydrocarbyl with at least one but not all the catenated carbon atoms replaced with a heteroatom selected from oxygen (—O—), sulfur (—S—), and nitrogen (e.g., —NH—).

The term “(hetero)hydrocarbyl” refers to a hydrocarbyl, heterohydrocarbyl, or both.

The term “heterohydrocarbylene” refers to a hydrocarbylene with at least one but not all the catenated carbon atoms replaced with a heteroatom selected from oxygen (—O—), sulfur (—S—), and nitrogen (e.g., —NH—).

The term “(hetero)hydrocarbylene” refers to a hydrocarbylene, heterohydrocarbylene, or both.

The term “heteroaralkylene” refers to an aralkylene having a heteroatom in the aryl group. Stated differently, it is an alkylene bonded to a heteroaryl where a heteroaryl is an aryl having one of the ring carbon atoms replaced with a heteroatom selected from oxygen (—O—), sulfur (—S—), and nitrogen (e.g., —NH—).

The term “hydrogen bond acceptor” refers to a heteroatom selected from oxygen, nitrogen, and sulfur that has a lone electron pair. The hydrogen bond acceptor is often carbonyl, carbonyloxy, or ether oxygen.

The term “hydrogen bond donor” refers to a moiety consisting of a hydrogen atom covalently bonded to a heteroatom selected from oxygen, nitrogen, and sulfur. The hydrogen bond donor is often imino, thio, or hydroxy.

The term “hydrogen bonding moiety” means a moiety that includes at least one hydrogen bond donor and at least one hydrogen bond acceptor.

The term “iminocarbonylimino” means a divalent group or moiety of formula —N(R^{e})—C(═O)—N(R^{e})—, wherein each R^{e} is independently hydrogen, alkyl (for example, selected from alkyl groups having from one to four carbon atoms), or aryl. Often one or both R^{e} groups are hydrogen.

The term “iminothiocarbonylimino” means a divalent group or moiety of formula —N(R^{e})—C(═S)—N(R^{e})—, wherein each R^{e} is independently hydrogen, alkyl (for example, selected from alkyl groups having from one to four carbon atoms), or aryl. Often one or both R^{e} groups are hydrogen.

The term “isocyanato” means a group of formula —N═C═O.

The term “modified substrate” refers to a polymeric substrate (e.g., porous polymeric substrate) having a plurality of covalently attached thiocarbonylthio-containing groups or semi-pinacol-containing groups.

The term “oxycarbonylimino” means a divalent group or moiety of formula —O—C(═O)—N(R^{e})—, wherein R^{e} is hydrogen, alkyl (for example, selected from alkyl groups having from one to four carbon atoms), or aryl. Often the R^{e} group is hydrogen.

The term “oxythiocarbonylimino” means a divalent group or moiety of formula —O—C(═S)—N(R^{e})—, wherein R^{e} is hydrogen, alkyl (for example, selected from alkyl groups having from one to four carbon atoms), or aryl. Often the R^{e} group is hydrogen.

The term “ethylenically unsaturated” means a group of formula —CY═CH₂ where Y is hydrogen or hydrocarbyl (e.g., alkyl or aryl).

The terms “phosphonic acid group” and “phosphono” refer interchangeably to a group of formula —PO₃H₂, wherein this group is not attached to an oxygen atom (it is usually attached to a carbon atom). The phosphonic acid group can be present as a salt having a cationic counter ion.

The terms “phosphoric acid group” and “phosphato” refer interchangeably to a group of formula —OPO₃H₂. The phosphoric acid group can be present as a salt having a cationic counter ion.

The terms “polymer” and “polymeric material” are used interchangeably and refer to materials formed by reacting one or more monomers. The terms include homopolymers, copolymers, terpolymers, or the like. Likewise, the terms “polymerize” and “polymerizing” refer to the process of making a polymeric material that can be a homopolymer, copolymer, terpolymer, or the like.

The term “reversible deactivation radical polymerization” or “RDRP” refers to a polymerization process in which there is fast and reversible activation and deactivation of propagating chains. Although multiple RDRP techniques are available, the most common of these are: a) stable radical mediated polymerizations (e.g., nitroxide mediated polymerization or NMP), b) atom transfer radical polymerization (or ATRP), and c) reversible addition-fragmentation chain transfer polymerization (or RAFT). For a review of industrial utilization of these processes, see M. Destarac, Polymer Chemistry, 2018, Vol. 9, Issue 40, pp. 4947-4967. As used herein, processes mediated by a semi-pinacol-containing group are considered to be RDRP polymerization processes.

The term “semi-pinacol” refers to a monovalent group that is covalently attached to a substrate. The semi-pinacol group often has two aromatic rings connected through a carbon atom with the carbon atom also bonded to the substrate and to a hydroxy group. The semi-pinacol group is often of formula (A) or formula (B).

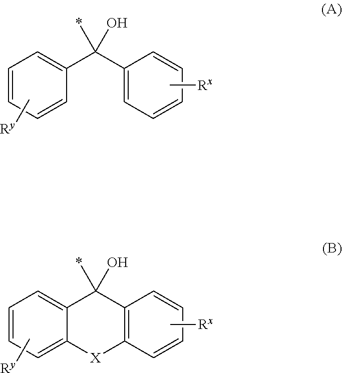

Each R^{x} and R^{y} is hydrogen, alkyl such as those having 1 to 4 carbon atoms, hydroxy, alkoxy such as those having 1 to 4 carbon atoms, halo, sulfo, or sulfoalkyleneoxy such as those having 1 to 4 carbon atoms. The group X is a single bond, an alkylene having 1 to 3 carbon atoms, or a heteroatom such as —O— or —S—. The asterisk (*) shows the attachment site of the semi-pinacol group to the substrate. The semi-pinacol group is typically formed by UV excitation of a Type II photoinitiator, which forms a semi-pinacol radical by hydrogen abstraction from the substrate to form a treated substrate radical. These two radicals then combine to covalently attach the semi-pinacol group to the substrate.

The terms “sulfonic acid group” and “sulfono” refer interchangeably to a group of formula —SO₃H, wherein this group is not attached to an oxygen atom (it is usually attached to a carbon atom). The sulfonic acid group can be present as a salt having a cationic counter ion.

The terms “sulfuric acid group” and “sulfato” refer interchangeably to a group of formula —OSO₃H. The sulfuric acid group can be present as a salt having a cationic counter ion.

The term “thiocarbonylimino” means a divalent group or moiety of formula —C(═S)NR^{e}—, where R^{e} is hydrogen, alkyl (for example, selected from alkyl groups having from one to four carbon atoms), or aryl. Group R^{e} is often hydrogen.

The term “thiocarbonylthio” refers to a divalent group —S—C(═S)—.

The term “treated substrate” refers to a polymeric substrate having a plurality of free radicals available for reaction with another compound such as a thiocarbonylthio-containing compound or a semi-pinacol radical.

The terms “in a range of” or “in the range of” are used interchangeably to refer to all values within the range plus the endpoints of the range.

The separation article comprises a porous polymeric substrate that is a solid and a plurality of block copolymers grafted to the porous polymeric substrate and extending away from a surface of the porous polymeric substrate. The block copolymers typically include a first polymeric block that is covalently attached to the porous polymeric substrate and a second polymeric block that is covalently attached to the first polymeric block with the first polymeric block positioned between the porous polymeric substrate and the second polymeric block. The first polymeric block has a plurality of acidic monomeric units or salts thereof, basic monomeric units or salts thereof, or a combination thereof while the second polymeric block has a plurality of polyether-containing monomeric units that can optionally be crosslinked.

The separation article can be prepared by grafting a plurality of first polymeric blocks to the porous polymeric substrate that is a solid using a reversible deactivation radical polymerization process, wherein the first polymeric blocks are covalently bonded to the porous polymeric substrate. In most embodiments, the first polymeric blocks are directly bonded to a carbon atom in the backbone of the polymeric material of the porous polymeric substrate. The first polymeric blocks are a reaction product of a first polymerizable composition comprising 1) an acidic monomer comprising an ethylenically unsaturated group and an acid group or salt thereof, 2) a basic monomer comprising an ethylenically unsaturated group and a basic group or salt thereof, or 3) a combination thereof. A plurality of second polymeric blocks are covalently bonded to the first polymeric blocks using the reversible deactivation radical polymerization process. The second polymeric blocks are a reaction product of a second polymerizable composition comprising a polyether-containing monomer comprising at least one ethylenically unsaturated group and a polyether group. The first polymeric block is positioned between the second polymeric block and the solid porous polymeric substrate. While additional polymeric blocks can be covalently attached to the second polymeric block, the separation article typically has a plurality of attached diblock copolymers.

### Porous Polymeric Substrate

The separation articles have a porous polymeric substrate that is a solid. The term “solid” in reference to the porous polymeric substrate means that the substrate is not a liquid and is not dissolved in a solution. The pores of the porous polymeric substrate can have any desired average size. In some embodiments, the pores are macro-porous, mesoporous, microporous, or a mixture thereof. As used herein, the term “macro-porous” refers to a polymeric substrate having pores with diameters greater than 50 nanometers, the term “meso-porous” refers a polymeric substrate having pores with diameters in a range of 2 nanometers to 50 nanometers, and the term “micro-porous” refers to a material having pores with diameters less than 2 nanometers.

The terms “solid porous polymeric substrate”, “porous polymeric substrate”, “polymeric substrate”, “substrate”, and similar variations can be used interchangeably herein.

The porous polymeric substrate can have any desired size, shape, and form. For example, the porous polymeric substrate can be in the form of particles, fibers, films, non-woven webs, woven webs, membranes, sponges, or sheets. In some examples, the polymeric substrate is a porous membrane or a porous non-woven web. To prepare large separation articles or many separation articles and for ease of manufacturing, the polymeric substrate can be in the form of or formed from a roll such as a roll of film, non-woven web, woven web, membrane, sponge, or sheet. This allows the use of roll-to-roll processing to prepare the separation articles. The porous polymeric substrate can include a single layer or multiple layers of the same or different polymeric materials.

The porous polymeric substrate is often formed from a thermoplastic material. Suitable thermoplastics include, but are not limited to, polyolefins, poly(isoprenes), poly(butadienes), fluorinated polymers, chlorinated polymers, polyamides, polyimides, polyethers, poly(ether sulfones), poly(sulfones), poly(vinyl acetates) and copolymers thereof such as poly(ethylene)-co-poly(vinyl acetate), polyesters such as poly(lactic acid), poly(vinyl alcohol) and copolymers thereof such as poly(ethylene)-co-poly(vinyl alcohol), poly(vinyl esters), poly(vinyl ethers), poly(carbonates), polyurethanes, poly((meth)acrylates) and copolymers thereof, and combinations thereof.

Suitable polyolefins for the porous polymeric substrate include poly(ethylene), poly(propylene), poly(1-butene), copolymers of ethylene and propylene, alpha olefin copolymers (such as copolymers of ethylene or propylene with 1-butene, 1-hexene, 1-octene, and 1-decene), poly(ethylene-co-1-butene), poly(ethylene-co-1-butene-co-1-hexene), poly(butadiene) and copolymers thereof, and combinations thereof.

Suitable fluorinated polymers for the porous polymeric substrate include poly(vinyl fluoride), poly(vinylidene fluoride), copolymers of vinylidene fluoride (such as poly(vinylidene fluoride-co-hexafluoropropylene)), copolymers of chlorotrifluoroethylene (such as poly(ethylene-co-chlorotrifluoroethylene)), and combinations thereof.

Suitable polyamides for the porous polymeric substrate include various nylon compositions such as, for example, poly(iminoadipoyliminohexamethylene), poly(iminoadipoyliminodecamethylene), polycaprolactam, and combinations thereof. Suitable polyimides include poly(pyromellitimide), and combinations thereof.

Suitable poly(ether sulfones) for the porous polymeric substrate include poly(diphenylether sulfone), poly(diphenylsulfone-co-diphenylene oxide sulfone), and combinations thereof.

Suitable copolymers of vinyl acetate for the porous polymeric substrate include copolymers of ethylene and vinyl acetate as well as terpolymers of vinyl acetate, vinyl alcohol, and ethylene.

In some embodiments, the porous polymeric substrate is a porous membrane having an average pore size (average longest diameter of the pore) that is often greater than 0.1 micrometer to minimize size exclusion separations, minimize diffusion constraints, and maximize surface area and separation. Generally, the average pore size can be in the range of 0.1 to 10 micrometers. For example, the average pore size is at least 0.2 micrometers, at least 0.4 micrometers, at least 0.6 micrometers, or at least 0.8 micrometers and up to 8 micrometers, up to 6 micrometers, up to 4 micrometers, or up to 2 micrometers.

The porous polymeric substrate can be a macro-porous membrane such as a thermally induced phase separation (TIPS) membrane. TIPS membranes are often prepared by forming a solution of a thermoplastic material and a second material above the melting point of the thermoplastic material. Upon cooling, the thermoplastic material crystallizes and phase separates from the second material. The crystallized material is often stretched. The second material is optionally removed either before or after stretching. Macro-porous membranes are further described in U.S. Pat. No. 4,539,256 (Shipman), U.S. Pat. No. 4,726,989 (Mrozinski), U.S. Pat. No. 4,867,881 (Kinzer), U.S. Pat. No. 5,120,594 (Mrozinski), U.S. Pat. No. 5,260,360 (Mrozinski), and U.S. Pat. No. 5,962,544 (Waller, Jr.). Some exemplary TIPS membranes include poly(vinylidene fluoride) (PVDF), polyolefins such as poly(ethylene) or poly(propylene), vinyl-containing polymers or copolymers such as ethylene-vinyl alcohol copolymers and butadiene-containing polymers or copolymers, and (meth)acrylate-containing polymers or copolymers. TIPS membranes including PVDF are further described in U.S. Pat. No. 7,338,692 (Smith et al.).

In some embodiments, the porous polymeric substrate can include a nylon macro-porous film or sheet (for example, a macro-porous membrane), such as those described in U.S. Pat. No. 6,056,529 (Meyering et al.), U.S. Pat. No. 6,267,916 (Meyering et al.), U.S. Pat. No. 6,413,070 (Meyering et al.), U.S. Pat. No. 6,776,940 (Meyering et al.), U.S. Pat. No. 3,876,738 (Marinaccio et al.), U.S. Pat. No. 3,928,517 (Knight et al.), U.S. Pat. No. 4,707,265 (Barnes, Jr. et al.), and U.S. Pat. No. 5,458,782 (Hou et al.).

In other embodiments, the porous polymeric substrate can be a nonwoven web, which can include nonwoven webs manufactured by any of the commonly known processes for producing nonwoven webs. As used herein, the term “nonwoven web” refers to a fabric that has a structure of individual fibers or filaments that are randomly and/or unidirectionally interlaid in a mat-like fashion.

For example, the fibrous nonwoven web can be made by wet laid, carded, air laid, spunlaced, spunbonding, or melt-blowing techniques, or combinations thereof. Spunbonded fibers are typically small diameter fibers that are formed by extruding molten thermoplastic polymer as filaments from a plurality of fine, usually circular capillaries of a spinneret, with the diameter of the extruded fibers being rapidly reduced. Melt-blown fibers are typically formed by extruding molten thermoplastic material through a plurality of fine, usually circular, die capillaries as molten threads or filaments into a high velocity, usually heated gas (for example, air) stream, which attenuates the filaments of molten thermoplastic material to reduce their diameter. Thereafter, the melt-blown fibers are carried by the high velocity gas stream and are deposited on a collecting surface to form a web of randomly dispersed, melt-blown fibers. Any of the nonwoven webs can be made from a single type of fiber or from two or more fibers that differ in the type of thermoplastic polymer and/or thickness.

Further details of manufacturing methods of useful nonwoven webs have been described by Wente in “Superfine Thermoplastic Fibers,” Indus. Eng. Chem., 48, 1342 (1956) and by Wente et al. in “Manufacture of Superfine Organic Fibers,” Naval Research Laboratories Report No. 4364 (1954).

The nonwoven web substrate may optionally further comprise one or more layers of scrim. For example, either or both major surfaces of the nonwoven web may each optionally further comprise a scrim layer. The scrim, which is typically a woven or nonwoven reinforcement layer made from fibers, is included to provide strength to the nonwoven web. Suitable scrim materials include, but are not limited to, nylon, polyester, fiberglass, polyethylene, polypropylene, and the like. The average thickness of the scrim can vary but often ranges from about 25 to about 100 micrometers, preferably about 25 to about 50 micrometers. The scrim layer may optionally be bonded to the nonwoven article, A variety of adhesive materials can be used to bond the scrim to the nonwoven. Alternatively, the scrim may be heat-bonded to the nonwoven web.

The porosity of nonwoven substrates is typically characterized by properties such as fiber diameter, or basis weight, or solidity, rather than by pore size. The fibers of the nonwoven substrate are typically microfibers having an effective fiber diameter of from at least 0.5, 1, 2, or even 4 micrometers and at most 15, 10, 8, or even 6 micrometers, as calculated according to the method set forth in Davies, C. N., “The Separation of Airborne Dust and Particles,” Institution of Mechanical Engineers, London, Proceedings 1B, 1952. The nonwoven substrate preferably has a basis weight in the range of at least 5, 10, 20, or even 50 g/m²; and at most 800, 600, 400, 200, or even 100 g/m². The minimum tensile strength of the nonwoven web is about 4.0 Newtons. It is generally recognized that the tensile strength of nonwoven substrates is lower in the machine direction than in the cross-web direction due to better fiber bonding and entanglement in the latter. Nonwoven web loft is measured by solidity, a parameter that defines the solids fraction in a volume of web Lower solidity values are indicative of greater web loft. Solidity (a) is a unitless fraction typically represented by: α=m_{f}÷ρ_{f}×L_{nonwoven} where m_{f} is the fiber mass per sample surface area, ρ_{f} is the fiber density, and L_{nonwoven} is the nonwoven thickness. Solidity is used herein to refer to the nonwoven substrate itself and not to the functionalized nonwoven substrate. When a nonwoven substrate contains mixtures of two or more kinds of fibers, the individual solidities are determined for each kind of fiber using the same L_{nonwoven} and these individual solidities are added together to obtain the web's solidity, α.

### Grafting First Polymeric Block to Porous Polymeric Substrate

A plurality of block copolymers are grafted to the surface of the porous polymeric substrate using reversible deactivation radical polymerization (RDRP), which is sometimes referred to as controlled radical polymerization. With this polymerization method, free radical polymerization can occur under conditions that mimic living polymerization methods in the sense that termination reactions are minimized such as described, for example, in article by N. Corrigan et al. in Progress in Polymer Science, 2020, 111, 101311. Using RDRP, the polymer architecture, microstructure, molecular weight, and molecular weight distribution typically can be controlled for solution polymerization reactions.

RDRP processes can be utilized to covalently modify porous substrates. Attachment of RDRP initiators to substrates allows one to conduct surface-initiated RDRP (SI-RDRP), or graft polymerization from the surface of the substrate (see above Progress in Polymer Science article). Attachment of RDRP initiators to porous polymeric substrates is often quite difficult, involving multiple synthetic steps, and can be very substrate dependent. The porous polymeric substrate typically must have a functional group to which the RDRP initiator can be covalently attached, usually via a condensation reaction. For example, carboxylic acid containing-RDRP agents can be covalently attached to cellulose membranes or fibers by esterification onto the cellulose hydroxyl groups. If an appropriate functional group is not available, the substrate must first be modified chemically to introduce the functional group.

A simple, industrially feasible process for directly attaching RDRP agents to solid polymeric substrates without the need for chemical modification was described in U.S. Patent Application Publication 2021/0095088 (Rasmussen et al.). More specifically, a plurality of thiocarbonylthio-containing groups can be directly and covalently bonded to the solid porous polymeric substrate. The thiocarbonylthio-containing group is typically directly and covalently attached to a carbon atom in the backbone of the polymeric material in the polymeric substrate. These modified substrates with directly attached RDRP agents (e.g., thiocarbonylthio-containing groups) can be used as RDRP initiators or photoiniferters. This approach allows the grafting of a variety of free radically polymerizable monomers to the substrates as shown in U.S. Patent Application Publication 2020/0368694 (Rasmussen et al.). This approach is referred to herein as “Grafting Method 1” and is further described below.

In another simple, industrially feasible process, the RDRP agents are combined in solution with the monomers. Unlike Grafting Method 1, there is no separate step of forming a modified substrate having a plurality of directly and covalently attached thiocarbonylthio-containing groups that occurs before polymerization of the monomers. Rather, a thiocarbonylthio-containing compound and a Type II photoinitiator are combined in solution with the monomers. The solution is coated on the substrate and then the coated substrate is subjected to actinic irradiation (e.g., UV irradiation). If a photoactive substrate is used, the Type II photoinitiator is optional. This method is referred to herein as “Grafting Method 2” and is further described below.

In a modification of “Grafting Method 2”, a substrate is converted to a treated substrate via e-beam irradiation and then the treated substrate is combined with a solution comprising monomers and a RDRP agent.

The thiocarbonylthio-containing compound and thiocarbonylthio-containing groups can be any of those known to be useful as RAFT agents such as those described in Moad et al., Aust. J. Chem, 2005, 58, 279-410. Suitable RAFT agents are described in this reference as being those of formula R—S—C(═S)—Z where Z is selected to activate or deactivate the thiocarbonyl double bond to modify the stability of intermediate radical while R is the free-radical leaving group. This reference instructs that the RAFT agents should have a reactive C═S double bond, the S—R bond should fragment readily (i.e., this bond should be weak) and give no side reactions, and the expelled radical (R*) should efficiently re-initiate polymerization.

While any known RAFT agents can be used herein including all of those described in the reference above by Moad et al., particularly with Grafting Method 2, it may be advantageous to select RAFT agents having a thiocarbonylthio-group of formula —S—C(═S)—R¹. Group R¹ in this thiocarbonylthio-containing group is typically selected to be an alkoxy, aralkyloxy, alkenyloxy or —N(R⁴)₂. Each R⁴ is an alkyl or two adjacent R⁴ groups are combined with the nitrogen to which they are both attached to form a first heterocyclic ring having 1 to 3 heteroatoms selected from nitrogen, oxygen, and sulfur, the first heterocyclic ring being saturated or unsaturated and optionally fused to one or more second rings that are carbocyclic or heterocyclic. While such thiocarbonylthio-containing compounds may be advantageous when using either Grafting Method 1 or Grafting Method 2, these compounds are particularly advantageous when using Grafting Method 1. The thiocarbonyl-containing groups selected for use in Grafting Method 1 are often not those that are typical agents for reversible addition-fragmentation chain transfer (RAFT) polymerization reactions.

Suitable alkoxy groups for R¹ typically have at least 1 carbon atom, at least 2 carbon atoms, at least 3 carbon atoms, or at least 4 carbon atoms and can have up to 20 carbon atoms, up to 18 carbon atoms, up to 16 carbon atoms, up to 12 carbon atoms, or up to 10 carbon atoms. Some example alkoxy groups have 1 to 20 carbon atoms, 1 to 10 carbon atoms, 2 to 10 carbon atoms, 1 to 6 carbon atoms, 2 to 6 carbon atoms, or 1 to 4 carbon atoms.

Suitable alkenyloxy groups for R¹ typically have at least 2 carbon atoms, at least 3 carbon atoms, or at least 4 carbon atoms and can have up to 20 carbon atoms, up to 18 carbon atoms, up to 16 carbon atoms, up to 12 carbon atoms, or up to 10 carbon atoms. Some example alkenyloxy groups have 2 to 20 carbon atoms, 2 to 10 carbon atoms, 2 to 6 carbon atoms, or 2 to 4 carbon atoms.

Suitable aralkyloxy groups for R¹ typically contains an alkylene group having 1 to 10 carbon atoms, 1 to 6 carbon atoms, or 1 to 4 carbon atoms and an aryl group having 5 to 12 carbon atoms, 6 to 12 carbon atoms, or 6 to 10 carbon atoms. The aryl group in the aralkyloxy group is often phenyl.

In some embodiments of the thiocarbonylthio-containing group, R¹ is of formula —N(R⁴)₂ where each R⁴ is an alkyl or where the two adjacent R⁴ groups are combined with the nitrogen to which they are both attached to form a first heterocyclic ring having 1 to 3 heteroatoms selected from nitrogen, oxygen, and sulfur and 2 to 5 carbon atoms, the first heterocyclic ring being saturated or unsaturated (e.g., partially or fully unsaturated) and optionally fused to one or more second rings that are carbocyclic or heterocyclic.

Suitable alkyl R⁴ groups typically have at least 1 carbon atom, at least 2 carbon atoms, at least 3 carbon atoms, or at least 4 carbon atoms and can have up to 20 carbon atoms, up to 18 carbon atoms, up to 16 carbon atoms, up to 12 carbon atoms, or up to 10 carbon atoms. Some example alkyl groups have 1 to 20 carbon atoms, 1 to 10 carbon atoms, 2 to 10 carbon atoms, 1 to 6 carbon atoms, 2 to 6 carbon atoms, or 1 to 4 carbon atoms.

When the formula —N(R⁴)₂ forms a first heterocyclic ring, the heterocyclic ring typically has a first ring structure with 5 to 7 ring members or 5 to 6 ring members and with 1 to 3 heteroatoms or 1 to 2 heteroatoms in the ring. Ring members that are not a heteroatom are carbon. If there is one heteroatom in the first ring structure, the heteroatom is nitrogen. If there are two or three heteroatoms in the first ring structure, one heteroatom is nitrogen and any additional heteroatom is selected from nitrogen, oxygen, and sulfur. The first ring optionally can be fused to one or more second ring structures that are heterocyclic or carbocyclic and saturated or unsaturated (e.g., partially or fully unsaturated). If the second ring structure is heterocyclic, it typically has 5 to 7 or 5 to 6 ring members and 1, 2, or 3 heteroatoms selected from nitrogen, oxygen, and sulfur. If the second ring structure is carbocyclic, it is often benzene or a saturated ring having 5 or 6 ring members. In many embodiments, the heterocyclic ring has a single ring structure with 5 or 6 ring members and with either 1 or 2 heteroatoms in the ring. Examples of heterocyclic rings include, but are not limited to, morpholino, thiomorpholino, pyrrolidinyl, piperidinyl, homo-piperidinyl, indolyl, carbazolyl, imidazolyl, and pyrazolyl.

The thiocarbonylthio-containing compounds are often of general formula Q-S—C(═S)—R¹ wherein Q is the remainder of the compound. Group Q can include a second group (or even a third group) of formula —S—C(═S)—R¹ if the thiocarbonylthio-containing compound contains more than one such group. Group R¹ is the same as defined above. These thiocarbonylthio-containing compound can be referred to interchangeably as RAFT agents or as iniferters (e.g., photoiniferters).

Some example thiocarbonylthio-containing compounds of general formula Q-S—C(═S)—R¹ are the symmetrical compounds of Formula (I).

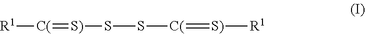

Group R¹ in the thiocarbonylthio-containing group is typically selected to be an alkoxy, aralkyloxy, alkenyloxy or —N(R⁴)₂. Each R⁴ is an alkyl or two adjacent R⁴ groups are combined with the nitrogen to which they are both attached to form a first heterocyclic ring having 1 to 3 heteroatoms selected from nitrogen, oxygen, and sulfur, the first heterocyclic ring being saturated or unsaturated and optionally fused to one or more second rings that are carbocyclic or heterocyclic.

Examples of thiocarbonylthio-containing compounds of Formula (I) include, but are not limited to, dixanthogen (where R¹ is an ethoxy) and tetraethylthiuram disulfide (where is R¹ is of formula —N(R⁴)₂ where each R⁴ is ethyl).

Other example thiocarbonylthio-containing compounds of general formula Q-S—C(═S)—R¹ are of Formula (II).

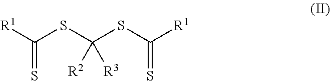

In Formula (II), each R¹ is an alkoxy, aralkyloxy, alkenyloxy, or —N(R⁴)₂. Suitable alkoxy, aralkyloxy, alkenyloxy, and —N(R⁴)₂ groups for R¹ are the same as described above for the thiocarbonylthio-containing group. Group R² is of formula —(OR₅)_{q}—OR⁶ or of formula —C(═O)—X—R⁷. Group R³ is hydrogen, alkyl, aryl, substituted aryl (i.e., an aryl substituted with at least one alkyl, alkoxy, or halo), alkaryl, a group of formula —C(═O)—OR⁸, or a group of formula —C(═O)—N(R⁹)₂. Group R⁵ is an alkylene, group R⁶ is an alkyl, and q is an integer equal to at least 0. Group R⁷ is hydrogen, alkyl, aryl, aralkyl, or substituted aryl (i.e., an aryl substituted with at least one alkyl, alkoxy, or halo). Group R⁸ and R⁹ are each independently an alkyl, aryl, aralkyl, or alkaryl. Group X is a single bond, oxy, or —NR¹⁰. Group R¹⁰ is hydrogen, alkyl, aryl, aralkyl, or alkaryl. The compounds of Formula (II) can be formed using any suitable method such as those described in U.S. Patent Application Publication 2021/0095088 (Rasmussen et al.).

Examples of thiocarbonylthio-containing compounds of Formula (II) include, but are not limited to, 1,1-bis(10-undecenyloxycarbothioylsulfanyl)methyl ether, methyl 2,2-bis(isopropoxycarbothioylsulfanyl)-2-methoxy-acetate, 1,1-bis(isopropoxycarbothioylsulfanyl)methyl methyl ether, 1,1-bis(isopropoxycarbothioylsulfanyl)methyl butyl ether, 1,1-bis(ethoxycarbothioylsulfanyl)methyl butyl ether, 2-ethylhexyl 2,2-bis(isopropoxycarbothioylsulfanyl)acetate, methyl 2,2-bis(isopropoxycarbothioylsulfanyl)acetate, tert-butyl 2,2-bis(isopropoxycarbothioylsulfanyl)acetate, 1,1-bis(isopropoxycarbothioylsulfanyl)-2-propanone, 2,2-bis(isopropoxycarbothioylsulfanyl)-1-phenyl ethanone and 2,2-bis(isopropoxycarbothioylsulfanyl)-1-(4-bromophenyl) ethenone, phenyl 2,2-bis(isopropoxycarbothioylsulfanyl)acetate, N,N-dibutyl-2,2-bis(isopropoxycarbothioylsulfanyl)acetamide, 1,1-bis(diethylcarbamothioylsulfanyl)methyl butyl ether, 1,1-bis(diethylcarbamothioylsulfanyl)methyl methyl ether, 2-ethylhexyl 2,2-bis(diethylcarbamothioylsulfanyl)acetate, methyl 2,2-bis(diethylcarbamothioylsulfanyl)acetate, and octyl 2,2-bis(diethylcarbamothioylsulfanyl)acetate.

Other example thiocarbonylthio-containing compounds of general formula Q-S—C(═S)—R¹ are of Formula (III).

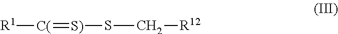

Group R¹ is the same as defined above for the thiocarbonylthio-containing group. R¹² is a group of formula —C(═O)—OR¹³ where each R¹³ is hydrogen, alkyl, aryl, aralkyl, or alkaryl, a group of formula —C(═O)—R¹⁴ where each R¹⁴ is independently alkyl, aryl, aralkyl, or alkaryl, a group of formula —OR¹⁵ where R¹⁵ is alkyl, aryl, aralkyl, or alkaryl, or a group of formula —C(═O)—N(R¹⁶)₂ where R¹⁶ is each independently hydrogen or alkyl. When R¹³ is hydrogen, the R¹² group may be neutralized such that it is a group of the formula —C(═O)—O⁻M⁺, where M+ is an alkali metal ion, a tetraalkylammonium ion, a trialkylammonium ion, or a dialkylammonium ion.

Specific examples of thiocarbonylthio-containing compounds of Formula (III) include, but are not limited to, methyl 2-ethoxycarbothioylsulfanylacetate, O-ethyl-(2-amino-2-oxo-ethyl)sulfanylmethanethioate, (isopropoxycarbothioylsulfanyl)methyl octyl ether 2-ethoxycarbothioylsulfanylacetate, sodium salt. The preparation of these compounds is described in U.S. Patent Application Publication 2021/0095088 (Rasmussen et al.).

Using Grafting Method 1, thiocarbonylthio-containing groups are grafted to the surface of the porous polymeric substrate to form a modified substrate. The polymeric substrate itself is typically free of thiocarbonylthio-containing groups. That is, the polymeric substrate does not include a polymeric material having thiocarbonylthio-containing groups (e.g., a (meth)acrylate polymer having pendant thiocarbonylthio-containing groups) and/or does not include a coating layer that includes a polymeric material having thiocarbonylthio-containing groups. Alternatively, additional thiocarbonyl-containing groups can be grafted to a polymeric substrate or to a coating layer that contains thiocarbonylthio-containing groups. Grafting can substantially increase the density of the thiocarbonylthio-containing groups on the surface of the polymeric substrate.

The modified substrate has a plurality of thiocarbonylthio-containing groups directly and covalently attached to the surface of the porous polymeric substrate. The thiocarbonylthio-containing groups are typically covalently attached to carbon atoms on a polymeric backbone of the porous polymeric substrate. The thiocarbonylthio-containing groups are covalently attached by reacting with a free radical on a surface of the porous polymeric substrate. Various methods can be used to generate the free radicals on this surface. Polymeric substrates having free radicals available for further reaction are referred to as “treated substrates”.

In a first method of forming a treated substrate, an imbibing solution is prepared. The imbibing solution contains a Type II photoinitiator dissolved in a solvent. The solvent can include water and/or organic solvents. The imbibing solution is applied to a surface of the porous polymeric substrate as a coating layer. The coating layer is then exposed to actinic radiation, which is typically in the ultraviolet region of the electromagnetic spectrum. Upon exposure to the actinic radiation, the Type II photoinitiator abstracts a hydrogen from the porous polymeric substrate resulting in the generation of free radicals on its surface and the formation of the treated substrate.

Type II photoinitiators included in the imbibing solution are typically aromatic ketone compounds. Examples include, but are not limited to, benzophenone, carboxybenzophenone (e.g., 3-carboxybenzophenone), 4-(3-sulfopropyloxy)benzophenone sodium salt, Michler's ketone, benzil, anthraquinone, 5,12-naphthacenequinone, aceanthracenequinone, benz(A)anthracene-7,12-dione, 1,4-chrysenequinone, 6,13-pentacenequinone, 5,7,12,14-pentacenetetrone, 9-fluorenone, anthrone, xanthone, thioxanthone, 2-(3-sulfopropyloxy)thioxanthen-9-one, acridone, dibenzosuberone, acetophenone, and chromone.

The imbibing solution can contain any suitable amount of the Type II photoinitiator. The concentration is often in a range of 0.1 to 20 weight percent based on a total weight of the Type II photoinitiator and the solvent. For example, the concentration can be at least 0.2 weight percent, at least 0.5 weight percent, at least 1 weight percent, at least 2 weight percent, or at least 5 weight percent and, depending on its solubility in the solvent, can be up to 20 weight percent, up to 16 weight percent, up to 12 weight percent, up to 10 weight percent, up to 8 weight percent, up to 6 weight percent, or up to 5 weight percent.

Suitable solvents for use in the imbibing solution are typically organic solvents but can be water (when the Type II photoinitiator is water soluble) or a mixture of water and an organic solvent. Suitable non-protic polar organic solvents include esters (e.g., ethyl acetate, propyl acetate), alkoxyalkyl acetates (e.g., methoxyethyl acetate, ethoxyethyl acetate, propoxyethyl acetate, and butoxyethyl acetate), trialkyl phosphates such as triethylphosphate, ketones (e.g., acetone, methyl ethyl ketone, methyl propyl ketone, and methyl isobutyl ketone), sulfoxides (e.g., dimethyl sulfoxide), and mixtures thereof. Suitable protic polar organic solvents include alcohols (e.g., methanol, ethanol, propanol, isopropanol, n-butanol, and tert-butyl alcohol), glycols (e.g., ethylene glycol and propylene glycol), glycol ethers (e.g., methoxyethanol, ethoxyethanol, propoxyethanol, butoxyethanol, methyl carbitol and ethyl carbitol), and mixtures thereof. The solvent can be water (for example, when the Type II photoinitiator is soluble in water) or can be an organic solvent mixed with water, if desired. Suitable nonpolar organic solvents include alkanes (e.g., pentane, hexane, heptane, isooctane, and decane), aromatic solvents (e.g., benzene, toluene, and xylene), and ethers (e.g., diethyl ether, tetrahydrofuran, dioxane). Although they may be useful in some instances, most alcohols and ethers are not preferred as solvents due to their propensity for undergoing interfering hydrogen abstraction reactions.

Any method of application of the imbibing solution can be used. In many processes, the imbibing solution is applied as a coating layer to the polymeric substrate. Pressure optionally can be applied to remove air bubbles and excess imbibing solution before exposing the treated substrate to actinic radiation. For example, a cover film that is transparent to the actinic radiation can be applied such that the imbibing coating layer is positioned between the polymeric substrate and the cover film. Pressure can be applied to the surface of the cover film opposite the imbibing coating.

The source of actinic radiation is often an ultraviolet (UV) light source. UV light can be provided by various light sources such as light emitting diodes (LEDs), black lights, medium pressure mercury lamps, etc. or a combination thereof. The actinic radiation can also be provided with higher intensity light sources such as those available from Fusion UV Systems Inc. The ultraviolet light sources can be relatively low light intensity sources such as blacklights that provide generally 10 mW/cm² or less (as measured in accordance with procedures approved by the United States National Institute of Standards and Technology as, for example, with a UVIMAP™ UM 365 L-S radiometer manufactured by Electronic Instrumentation & Technology, Inc., in Sterling, VA) over a wavelength range of 280 to 400 nanometers. Alternatively, relatively high light intensity sources such as medium pressure mercury lamps can be used that provide intensities generally greater than 10 mW/cm², preferably between 15 and 450 mW/cm². The exposure time can be up to about 30 minutes or even longer.

In some embodiments, it is preferable to use lights that emit a narrow spectrum of light in the ultraviolet region of the electromagnetic spectrum. These light sources, which include LEDs and lasers, can enhance the rate of free radical generation, or can enhance the rate of polymerization while maintaining the reactive nature of the polymeric material in subsequent monomer grafting steps.

The thiocarbonylthio-containing compound can be present when free radicals are generated on the surface of the solid polymeric substrates or can be introduced after generation of the free radicals. If the thiocarbonylthio-containing compound is present during free radical generation, it is typically dissolved in the imbibing solution along with the Type II photoinitiator. If the thiocarbonylthio-containing compound is not present during free radical generation, the intermediate semi-pinacol radical derived from the Type II photoinitiator via hydrogen abstraction typically couples with the radical on the surface of the substrate to form a semi-pinacol group. The thiocarbonylthio-containing compound can be applied as a second coating layer to the solid polymeric substrate comprising semi-pinacol groups. The coated substrate is again exposed to actinic radiation to regenerate the substrate radical and transfer the thiocarbonylthio-containing group to the surface of the substrate.

In another method useful for generating free radicals on a surface of the polymeric substrate, the substrate itself is photoactive and no Type II photoinitiator is needed. An imbibing solution is prepared containing the thiocarbonylthio-containing compound dissolved in a solvent. The imbibing solution is applied to a surface of the polymeric substrate as a coating layer. The coating layer is then exposed to actinic radiation, which is typically in the ultraviolet region of the electromagnetic spectrum. Upon exposure to the actinic radiation, the polymeric substrate absorbs enough energy that some of its covalent bonds are broken, resulting in the generation of free radicals on its surface and the formation of a treated substrate. The thiocarbonylthio-containing group is subsequently transferred to the substrate. Examples of photoactive polymeric substrates include polysulfones and poly(ether sulfones). Other photoactive polymeric substrates often contain an aromatic group such as, for example, homopolymers and block copolymers of poly(methylphenylsilane) and various polyimides based on benzophenone tetracarboxylic dianhydride.

In other methods for generating free radicals on a surface of the polymeric substrate, ionizing radiation is used rather than a Type II photoinitiator. As used herein, the term “ionizing radiation” refers to radiation that is of a sufficient dose and energy to form free radical reaction sites on the surface and/or in the bulk of the polymeric substrate. The radiation is of sufficient energy if it is absorbed by the polymeric substrate and results in the cleavage of chemical bonds in the substrate and the formation of free radicals. The ionizing radiation is often beta radiation, gamma radiation, electron beam radiation, x-ray radiation, plasma radiation, or other suitable types of electromagnetic radiation. Preferably, ionizing radiation is conducted in an inert environment to prevent oxygen from reacting with the radicals.

In many embodiments of this process, the ionizing radiation is electron beam radiation, gamma ray radiation, x-ray radiation, or plasma radiation because of the ready availability of suitable generators. Electron beam generators are commercially available such as, for example, the ESI ELECTROCURE EB SYSTEM from Energy Sciences, Inc. (Wilmington, MA, USA) and the BROADBEAM EB PROCESSOR from E-beam Technologies (Davenport, IA, USA). Gamma ray radiation generators are commercially available from MDS Nordion that use a cobalt-60 high energy source.

For any given type of ionizing radiation, the dose delivered can be measured in accordance with ISO/ASTM52628-13, “Standard Practice for Dosimetry in Radiation Processing,” by ASTM International (West Conshohocken, PA). By altering the extractor grid voltage, beam diameter, exposure time, and distance from the irradiation source, various dose rates can be obtained.

When ionizing radiation is used, the free radicals are typically formed on a surface of the polymeric substrate prior to contact with the thiocarbonylthio-containing compound. That is, there is a first step of generating the free radicals on the surface of the solid polymeric substrate to form a treated substrate and a second step of applying a coating layer of the thiocarbonylthio-containing compound to the treated substrate. The thiocarbonylthio-containing compound and the polymeric substrate having free radicals (i.e., treated substrate) react to covalently attach thiocarbonylthio-containing groups to the polymeric substrate forming a modified substrate.

The thiocarbonylthio-containing group is typically attached to (e.g., grafted to) the polymeric substrate in the modified substrate. In most cases, the thiocarbonylthio-containing group is directly attached to a carbon atom in the backbone of the polymeric material used to form the porous polymeric substrate. There is typically no intervening linking group such as an ester linkage, amide linkage, urethane linkage, ether linkage, siloxane linkage, or the like between the polymeric substrate and the thiocarbonyl-containing group.

The thiocarbonylthio-containing compound reacts with a porous polymeric substrate (PPS) as shown in Reaction Scheme A when Grafting Method 1 is used.

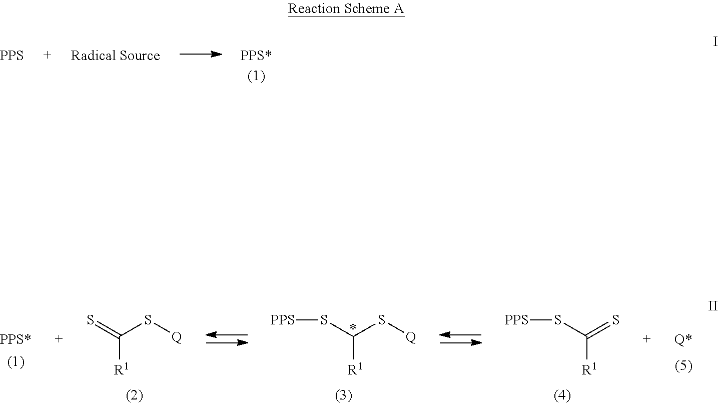

In Reaction Scheme A, free radical sites are first generated on the porous polymeric substrate (PPS) in Reaction I to form PPS*, which represents the porous polymeric substrate having free radicals (i.e., treated substrate) (1). When the thiocarbonylthio-containing compound (2) is contacted with the porous polymeric substrate having free radicals (1) in Reaction II, the group —S—C(═S)—R¹ is transferred to the porous polymeric substrate via an intermediate sulfur-stabilized radical (3) that subsequently expels the radical Q*(5). This results in a radical transfer from the surface of the substrate to group Q of the thiocarbonylthio-containing compound. Reaction (II) is indicated as being reversible; however, the reactions are not necessarily reversible provided the forward reactions can occur. The modified substrate is PPS—S—C(═S)—R¹ (4). Although Reaction Scheme A shows only one —S—C(═S)—R¹ group attached to the porous polymeric substrate for the sake of simplicity, there are a plurality of such attached groups on the modified substrate.

Group Q in the thiocarbonylthio-containing compound becomes a free radical during the transfer process shown in Reaction Scheme A. This group can be selected so that the S-Q bond is sufficiently weak to allow homolytic cleavage without any side reactions. In contrast to typical RAFT polymerization reactions, the expelled radical (Q*) does not need to be selected so that it can initiate free radical polymerization reactions because there are no monomers present at the time the thiocarbonylthio-containing group is covalently attached to the porous polymeric substrate using Grafting Method 1. This allows the use of thiocarbonylthio-containing compounds that would ordinarily not be used in typical RAFT controlled radical polymerization reactions.

Thus, the expelled radical (Q*) may be a primary radical, as opposed to the secondary or tertiary radicals used in typical RAFT polymerizations. The expelled radical may cause reversal of the transfer reaction (i.e., if the reactions shown in the second step of Reaction Scheme A are reversible, the covalently attached group —S—C(═S)—R¹ can combine with the expelled radical (Q*) to reform Q-S—C(═S)—R¹, resulting in the reformation of a radical on the surface of the substrate). Alternatively, the expelled radical (Q*) may become deactivated in a variety of radical termination processes well known in the art, such as by coupling to form Q-Q.

The amount of the thiocarbonylthio-containing groups attached to the polymeric substrate is typically in a range of 0.1 to 100 micromoles per gram of the modified substrate (i.e., micromoles per gram of the modified substrate). The amount is often at least 0.2, at least 0.5, at least 1, at least 2, at least 4, at least 5, or at least 10 micromoles per gram and is often up to 100, up to 80, up to 60, up to 40, up to 30, or up to 20 micromoles per gram.

In Grafting Method 1, the modified substrate PPS—S—C(═S)—R¹ is prepared as described above. The modified substrate, which has multiple thiocarbonylthio groups of formula —S—C(═S)—R¹ covalently attached to the surface of the polymeric substrate, is placed in contact with the first polymerizable composition to form a first reaction mixture. When the first reaction mixture is exposed to actinic radiation such as ultraviolet radiation, RDRP polymerization of the monomers within the first polymerizable composition can occur with the thiocarbonylthio-containing group functioning as a RAFT agent (e.g., an iniferter or photoiniferter). The polymerization process is shown schematically in Reaction Scheme B.

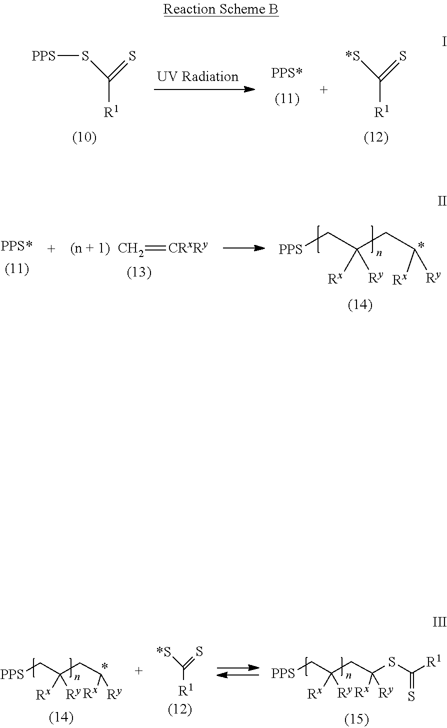

In Reaction Scheme B, exposure of the first reaction mixture to actinic radiation (e.g., ultraviolet radiation) results in formation of a radical on the porous polymeric substrate surface (11) and a radical of the thiocarbonylthio-containing group (12) as shown in Reaction I. A first monomer (shown for simplicity as CH₂═CR^{x}R^{y} (13) in Reaction Scheme B) reacts with the radical on the substrate surface (11) resulting in the generation of a second radical that can react with another monomer. The polymerization of the (n+1) moles of the first monomer is shown as the radical (14) in Reaction II. At any point in this process, the growing radical (14) may recombine with the thiocarbonylthio radical (12) to form a terminated chain as shown as product (15) in Reaction III. Upon continued exposure to actinic radiation, the radical (14) and the thiocarbonylthio radical (12) can form again from product (15). If more monomers are present, the regenerated radical (14) can undergo further polymerization. Eventually, this radical will combine with a thiocarbonylthio radical (12). The polymerization reaction stops when exposure to actinic radiation is stopped or there is no more monomer present. The product contains a plurality of first polymeric blocks grafted to the polymeric substrate. At least some of the first polymeric blocks are terminated with a thiocarbonylthio-containing group. Often, the thiocarbonylthio-containing group is of formula —S—C(═S)—R¹ as shown in the product (15) of Reaction III. To ensure that most of the first polymeric blocks are terminated with a thiocarbonylthio-containing group, a thiocarbonylthio-containing compound is often added to the first reaction mixture even though the substrate has attached thiocarbonylthio-containing groups.

No monomers having a radically polymerizable group such as an ethylenically unsaturated group are present when the thiocarbonylthio-containing compounds are reacted with the treated substrate using Grafting Method 1. This tends to increase the likelihood that the thiocarbonylthio group will be transferred to the treated substrate, and thus may increase the density of the thiocarbonylthio-containing groups on the surface of the polymeric substrate. This also allows the preparation and isolation of a modified substrate with covalently attached thiocarbonylthio-containing groups in the absence of any competing polymerization or grafting reactions and may allow better control over subsequent contemplated grafting (polymerization) reactions. There is no polymeric material formed in solution simultaneously with the formation of the modified substrate.

The product of Reaction Scheme B is an intermediate article with covalently attached first polymeric blocks. The first polymeric block is attached to (e.g., grafted to) the porous polymeric substrate. In most cases, the first polymeric block is directly and covalently attached to a carbon atom of the porous polymeric substrate. There is typically no intervening linking group such as an ester linkage, amide linkage, urethane linkage, ether linkage, siloxane linkage, or the like between the polymeric substrate and the first polymeric block. At least some of the first polymeric blocks are terminated with a thiocarbonylthio-containing group.

Alternatively, Grafting Method 2 can be used. Grafting Method 2 differs from Grafting Method 1 in that there is no separate step for formation of the modified substrate having a thiocarbonylthio-containing group covalently attached to the porous polymeric substrate. Rather, the first reaction mixture includes monomers for forming the first polymeric block, a thiocarbonylthio-containing compound, and an optional Type II photoinitiator. The Type II photoinitiator is not needed if the polymeric substrate is photoactive but is used for polymeric substrates that are not photoactive. The advantage of using Grafting Method 2 is that fewer steps are required to graft the first polymeric block onto the porous polymeric substrate.

In Grafting Method 2, exposure of the first reaction mixture to actinic radiation (e.g., ultraviolet radiation) results in formation of a radical on the porous polymeric substrate surface (PPS*). This radical can react with either the thiocarbonylthio-containing compound Q-S—C(═S)—R or a monomer (CH₂=CR^{X}Ry). Because the monomers are typically present in a higher concentration than the thiocarbonylthio-containing compound, the product is often like that of radical (14) shown in Reaction Scheme B. As in Reaction Scheme B, radical (14) can continue to grow if additional monomers are present. Eventually, the radical will be terminated by combining with a radical of the thiocarbonylthio-containing compound (12) to form the polymeric product (15). Upon continued exposure to actinic radiation, the radical (14) and the thiocarbonylthio radical (12) can form again from product (15). If more monomers are present, the regenerated radical (14) can undergo further polymerization. Eventually, this radical will combine with a thiocarbonylthio radical (12). The polymerization reaction stops when exposure to actinic radiation is stopped or there is no more monomer present. The product contains a plurality of first polymeric blocks grafted to the polymeric substrate. At least some of the first polymeric blocks are terminated with a thiocarbonylthio-containing group as shown in the product (15) of Reaction III of Reaction Scheme B.

Although the separation articles are advantageously formed using Grafting Method 1 or Grafting Method 2 with thiocarbonylthio-containing compounds such as those of Formulas (I), (II), or (III), other methods of forming the separation articles may be used. For example, the separation articles can be prepared using alternative reversible deactivation radical polymerization (RDRP) initiators or can be prepared with RDRP initiators using alternative processes.

In one alternative process that does not include thiocarbonylthio-containing compounds, an imbibing solution containing a Type II photoinitiator is coated on a porous polymeric substrate surface and then exposed to actinic radiation. Upon exposure to the actinic radiation, the Type II photoinitiator abstracts a hydrogen from the porous polymeric substrate resulting in the generation of free radicals on its surface and the formation of the treated substrate. The intermediate semi-pinacol radical derived from the Type II photoinitiator via hydrogen abstraction typically couples with the radical on the surface of the substrate to form a semi-pinacol group. This substrate with attached semi-pinacol groups can function as an RDRP initiator, as described in the article, for example, by H. Ma, et al., Macromolecules, 2000, 33, 331. Thus, the substrate with attached semi-pinacol groups can be coated with a first monomer solution, then exposed to actinic radiation to graft polymerize the first monomer to the substrate, resulting in covalently grafted polymer chains terminated with semi-pinacol groups. This method in which the first monomer solution is added after formation of the semi-pinacol groups on the substrate surface is referred to as Grafting Method 3.

In another alternative process that does not include thiocarbonylthio-containing compounds, an imbibing solution containing a first monomer and a Type II photoinitiator is coated on a porous polymeric substrate surface and then exposed to actinic radiation. Upon exposure to the actinic radiation, the Type II photoinitiator abstracts a hydrogen from the porous polymeric substrate resulting in the generation of free radicals on its surface and the formation of the treated substrate. The treated substrate then interacts with the first monomer to form grafted polymer chains covalently attached to the substrate. Finally, the semi-pinacol radical derived from the Type II photoinitiator via hydrogen abstraction couples with the radical on the polymer chain end to form grafted polymer chains having a semi-pinacol chain end, as described in the article by Yang and Ranby, Macromolecules, 1996, 29, 3308. This grafted substrate can be used to initiate polymerization of the second block. This method in which the first monomer is present at the same time as the Type II photoinitiator is referred to as Grafting Method 4.

In still other alternative processes, porous polymeric substrates having hydroxy or amino groups on their surface may be reacted with RDRP initiators containing a carboxylic acid or acid halide group to covalently attach the RDRP initiator though an ester or amide linkage. Such a reaction is shown below in Reaction Scheme C for the attachment of an atom transfer radical polymerization (ATRP) initiator.

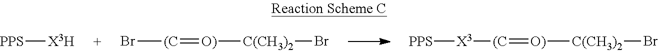

In this reaction scheme, X³ is —O— or —NH— and PPS refers to a porous substrate. The treated substrate PPS—X³—(C═O—C(CH₃)₂—Br has been used to graft ion exchange functionality to cellulose membranes (Bhut et al, J. Membr. Sci., 325 (2008), 176-183). Similarly, RAFT and NMP initiators have been attached to porous polymeric substrates. A review (Peng Liu, e-Polymers, 2007, No. 062) describes a wide variety of methods for attaching RDRP initiators to surfaces. Since these methods generally involve batch chemical processes for the attachment of the RDRP control agent to the substrate, they are not preferred methods for use in the current methods to form the separation article. However, the RDRP modified substrates can be useful as starting materials for the generation of the separation article having attached block copolymers described herein.

Regardless of the method of attaching the first block of the block copolymer to the porous polymeric substrate, the first polymerizable composition contains at least one first monomer that is an acidic monomer, a basic monomer, or a salt thereof. The first monomer can be in a neutral state but can be negatively charged (if acidic) or positively charged (if basic) under some pH conditions. The first monomer can be permanently charged (for example, when the ligand functional group is in the form of a quaternary ammonium salt). The acidic groups and the basic groups are not a polypeptide or protein. As used herein, the term “polypeptide” refers to a compound that contains more than four amino acid units.

The first monomer can include a single ethylenically unsaturated group or multiple ethylenically unsaturated groups (for example, two or three or up to as many as six), which can be the same or different in nature (preferably, the same). The first monomer often has only one ethylenically unsaturated group.

Suitable acidic groups of the first monomer include those that exhibit at least a degree of acidity (which can range from relatively weak to relatively strong), as well as salts thereof. Such acidic groups or salts thereof include those commonly utilized as ion exchange or metal chelate type ligands. The acid groups are often selected from a carboxylic acid group, phosphonic acid group, phosphoric acid group, sulfonic acid group, sulfuric acid group, boronic acid group, and salts thereof. If the acidic group is a salt, the counterion is often selected from an alkali metal (for example, sodium or potassium), alkaline earth metal (for example, magnesium or calcium), ammonium, and tetraalkylammonium, and the like, and combinations thereof.

Suitable acidic monomers include, for example, various sulfonic acids such as N-acrylamidomethanesulfonic acid, 2-acrylamidoethanesulfonic acid, 2-acrylamido-2-methyl-1-propanesulfonic acid, 2-methacrylamido-2-methyl-1-propanesulfonic acid, vinylsulfonic acid and 4-styrenesulfonic acid; (meth)acrylamidophosphonic acids such as (meth)acrylamidoalkylphosphonic acids such as 2-(meth)acrylamidoethylphosphonic acid and 3-(meth)acrylamidopropylphosphonic acid; (meth)acrylic acid; and carboxyalkyl(meth)acrylates such as 2-carboxyethyl(meth)acrylate, and 3-carboxypropyl(meth)acrylate. Still other suitable acidic monomers include (meth)acryloylamino acids, such as those described in U.S. Pat. No. 4,157,418 (Heilmann). Exemplary (meth)acryloylamino acids include, but are not limited to, N-acryloylglycine, N-acryloylaspartic acid, N-acryloyl-β-alanine, and 2-acrylamidoglycolic acid. Salts of any of these acidic monomers can also be used.

Suitable basic groups of the first monomer include those that exhibit at least a degree of basicity (which can range from relatively weak to relatively strong), as well as salts thereof. Such basic groups or salts thereof include those commonly utilized as ion exchange or metal chelate type ligands. The basic group is often a primary amino group, secondary amino group, tertiary amino group, quaternary amino group, guanidinium group, biguanidinium group, or a salt thereof. If the basic group is a salt, the counterion is often selected from a halide (e.g., chloride or bromide), carboxylate (e.g., acetate), nitrate, phosphate, bisulfate, methyl sulfate, hydroxide ions, and the like, and combinations thereof.

Suitable basic monomers include, for example, amino acrylates, amino(meth)acrylamides, and various monomers with quaternary ammonium groups. Exemplary amino acrylates include N,N-dialkylaminoalkyl acrylates such as, for example, N,N-dimethylaminoethylacrylate, N,N-dimethylaminoethylmethacrylate, N,N-diethylaminoethyl acylate, N,N-diethylaminoethylmethacrylate, N,N-dimethylaminopropylacrylate, N,N-dimethylaminopropylmethacrylate, N-tert-butylaminopropylmethacrylate, N-tert-butylaminopropylacrylate and the like. Exemplary amino (meth)acrylamides include, for example, N-(3-aminopropyl)methacrylamide, N-(3-aminopropyl)acrylamide, N-[3-(dimethylamino)propyl]methacrylamide, N-(3-imidazolylpropyl)methacrylamide, N-(3-imidazolylpropyl)acrylamide, N-(2-imidazolylethyl)methacrylamide, N-(1,1-dimethyl-3-imidazoylpropyl)methacrylamide, N-(1,1-dimethyl-3-imidazoylpropyl)acrylamide, N-(3-benzoimidazolylpropyl)acrylamide, and N-(3-benzoimidazolylpropyl)methacrylamide.

Exemplary monomers that have a quaternary ammonium group include, but are not limited to, (meth)acrylamidoalkyltrimethylammonium salts (e.g., 3-methacrylamidopropyltrimethylammonium chloride and 3-acrylamidopropyltrimethylammonium chloride) and (meth)acryloxyalkyltrimethylammonium salts (e.g., 2-acryloxyethyltrimethylammonium chloride, 2-methacryloxyethyltrimethylammonium chloride, 3-methacryloxy-2-hydroxypropyltrimethylammonium chloride, 3-acryloxy-2-hydroxypropyltrimethylammonium chloride, and 2-acryloxyethyltrimethylammonium methyl sulfate).

In some embodiments, using an acidic or basic monomer with a longer chain length between the ethylenically unsaturated group and either the acidic group or the basic group is advantageous. The acidic group or the basic group can be referred to as the “functional group” and the intervening group between the ethylenically unsaturated group and the acidic group or the basic group can be referred to as the “spacer group”. In some embodiments, the number of catenated atoms is at least 6, at least 8, at least 10, at least 12, at least 14, at least 16, at least 18, or at least 20 and up to 30, up to 28, up to 26, up to 24, up to 22, up to 20, up to 18, up to 16, up to 14, or up to 12. If the monomer has a (meth)acryloyl group, the carbonyl of this group is counted as being part of the spacer group.

Although not wishing to be bound by theory, the length of the spacer may contribute to adoption of helical or partially helical conformations by the polymer backbone (formed through monomer polymerization). When the spacer is relatively short (for example, less than 6 catenated atoms), ionic repulsion between acidic groups or between basic groups may force the polymer backbone into a random coil type conformation. As spacer chain length increases, adoption of helical conformations may become possible and may be maximized at spacer chain lengths of about 8 to about 14 catenated atoms. A helical conformation of substrate-grafted polymer may facilitate presentation of the acidic group(s), basic group(s), or salt(s) thereof, for interaction with target biomaterials, such as viruses and other microorganisms, proteins, cells, endotoxins, acidic carbohydrates, nucleic acids, and the like.

In certain embodiments, spacer groups include at least one hydrogen bonding moiety, which is defined above as a moiety including at least one hydrogen bond donor and at least one hydrogen bond acceptor (both of which are heteroatom-containing). Example hydrogen donors are imino, thio, and hydroxy groups. Example hydrogen acceptors are carbonyl, carbonyloxy, or ether oxygen. More preferred spacer groups include at least two hydrogen bonding moieties or include at least one hydrogen bonding moiety and at least one hydrogen bond acceptor that is distinct from (not part of) the hydrogen bonding moiety.

In certain embodiments, hydrogen bonding moieties include those that include at least two hydrogen bond donors (for example, donors such as imino, thio, or hydroxy), at least two hydrogen bond acceptors (for example, acceptors in the form of a carbonyl, carbonyloxy, or ether oxygen), or both. For example, an iminocarbonylimino moiety (having two N—H donors and at least two acceptors in the form of two lone electron pairs on carbonyl) can sometimes be preferred over a single iminocarbonyl moiety. In certain embodiments, the spacer groups include those that include at least one iminocarbonylimino moiety (more preferably, in combination with at least one acceptor such as carbonyloxy), at least two iminocarbonyl moieties, or a combination thereof.

The hydrogen bond donor and hydrogen bond acceptor of the hydrogen bonding moiety can be adjacent (directly bonded) to each other or can be non-adjacent (preferably, adjacent or separated by a chain of no more than 4 catenated atoms; more preferably, adjacent). The heteroatoms of the hydrogen bond donor and/or hydrogen bond acceptor can be located within the chain of catenated atoms of the spacer group or, alternatively, can be located within chain substituents.

Although hydrogen bond donors can also function as hydrogen bond acceptors (through a lone electron pair of the donor's heteroatom), the hydrogen bonding moiety preferably includes distinct donor and acceptor moieties. This can facilitate intramolecular (intermonomer) hydrogen bond formation. Although not wishing to be bound by theory, such intramolecular hydrogen bonds between adjacent monomer or near neighbor repeat units in the polymer molecule may contribute to at least a degree of spacer group stiffening, which may facilitate presentation of the acidic group(s), basic group(s), or salt(s) thereof for interaction with target biomaterials.

In certain embodiments, hydrogen bonding moieties include carbonylimino, thiocarbonylimino, iminocarbonylimino, iminothiocarbonylimino, oxycarbonylimino, oxythiocarbonylimino, and the like, and combinations thereof. In certain embodiments, hydrogen bonding moieties include carbonylimino, iminocarbonylimino, oxycarbonylimino, and combinations thereof (more preferably, carbonylimino, iminocarbonylimino, and combinations thereof). In certain embodiments, spacer groups include those that are divalent, trivalent, or tetravalent (more preferably, divalent or trivalent; and even more preferably, divalent).

A class of useful first monomers with a spacer group that has at least 6 catenated atoms are those of Formula (IV).

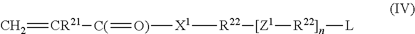

In Formula (IV), group R²¹ is selected from hydrogen or methyl. Each group R²² is independently a (hetero)hydrocarbylene. Group X¹ is —O— or —NR²³— where R²³ is selected from hydrogen or hydrocarbyl. Group Z¹ is heterohydrocarbylene with at least one hydrogen bond donor, at least one hydrogen bond acceptor, or a combination thereof. The variable n is an integer of 0 or 1. Group L is a ligand functional group that is an acidic group, a basic group, or salt thereof. Different compounds of Formula (IV) can be used in combination, if desired. The different compounds can both be acidic monomer or salts thereof, can both be basic monomers or salts thereof, or can be a combination of acid monomers and basic monomers or salts thereof. Additionally, the monomers of Formula (IV) can be used in combination with other acidic and/or basic monomers not of Formula (IV).

The monomers of Formula (IV) have an ethylenically unsaturated group of formula CH₂═CR²¹— where R²¹ is hydrogen or methyl.

Each R²² is independently a (hetero)hydrocarbylene. Example hydrocarbylenes include alkylene groups, arylene groups, aralkylene groups, and alkarylene groups. Example heterohydrocarbylenes include heteroaralkylene, hydroxy-substituted alkylene, and hydroxy-substituted aralkylene. In certain embodiments, each R²² is independently hydrocarbylene. For example, each R²² is independently alkylene.

Group X¹ is —O— (oxy) or —NR²³—. Group R²³ is hydrogen or hydrocarbyl. The hydrocarbyl can be an alkyl or aryl. In many examples, R²³ is hydrogen.

Group Z¹ is heterohydrocarbylene including at least one hydrogen bond donor, at least one hydrogen bond acceptor, or a combination thereof. Hydrogen donors are typically donors such as imino, thio, or hydroxy. Hydrogen acceptors are typically carbonyl, carbonyloxy, or ether oxygens. Thus, group Z¹ is often a hydrogen bonding moiety such as carbonylimino, thiocarbonylimino, iminocarbonylimino, iminothiocarbonylimino, oxycarbonylimino, oxythiocarbonylimino, and the like, and combinations thereof. In certain embodiments, hydrogen bonding moieties include carbonylimino, iminocarbonylimino, oxycarbonylimino, and combinations thereof (more preferably, carbonylimino, iminocarbonylimino, and combinations thereof).

The variable n is often an integer of 1 in the monomers of Formula (IV).

Group L is a ligand functional group including at least one acidic group or salt thereof selected from carboxy, phosphono, phosphato, sulfono, sulfato, boronato, and combinations thereof (more preferably, selected from carboxy, phosphono, sulfono, and combinations thereof). In other embodiments, L is a functional group including at least one basic group or salt thereof. The basic group is typically a tertiary amino group, a quaternary amino group, a guanidino group, or a biguanidino group. In some embodiments, L is a carboxy, guanidino, or a salt thereof.

Such monomers can be prepared by known synthetic methods or by analogy to known synthetic methods. For example, amino group-containing carboxylic, sulfonic, or phosphonic acids can be reacted with ethylenically unsaturated compounds that include at least one group that is reactive with an amino group. Similarly, acidic group-containing compounds that also contain a hydroxy group can be reacted with ethylenically unsaturated compounds that include at least one group that is reactive with a hydroxy group, optionally in the presence of a catalyst.

Preferred monomers are (meth)acryloyl-containing monomers, which refers to acryloyl-containing monomers and/or methacryloyl-containing monomers. Similarly, the term “(meth)acrylate” refers to an acrylate and/or a methacrylate monomer. In such monomers, the carbonyl group is part of the spacer group.

Representative examples of useful monomers of Formula (IV) can be prepared by reacting an alkenyl azlactone of Formula (V)

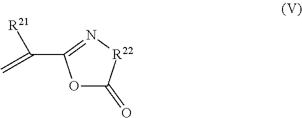

with a compound (or salt thereof) of Formula (VI).

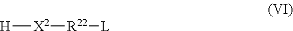

The groups R²¹, R²², and L are defined as in Formula (IV). Groups X² is oxy or —NR²³— where R²³ is hydrogen or hydrocarbyl (e.g., alkyl or aryl). The resulting compounds are of Formula (IV-1).

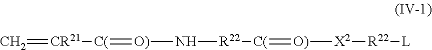

These compounds are of Formula (IV) where X¹ is —NH—, the variable n is equal to 1, and Z¹ is equal to —C(═O)—X²—.

Representative examples of useful alkenyl azlactones of Formula (V) include 4,4-dimethyl-2-vinyl-4H-oxazol-5-one (vinyldimethylazlactone, VDM), 2-isopropenyl-4H-oxazol-5-one, 4,4-dimethyl-2-isopropenyl-4H-oxazol-5-one, 2-vinyl-4,5-dihydro-[1,3]oxazin-6-one, 4,4-dimethyl-2-vinyl-4,5-dihydro-[1,3]oxazin-6-one, 4,5-dimethyl-2-vinyl-4,5-dihydro-[1,3]oxazin-6-one, and the like, and combinations thereof.

Other representative examples of useful monomers of Formula (IV) can be prepared by reacting an (meth)acryloyl isocyanate monomer of Formula (VII)

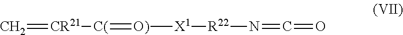

with a compound (or salt thereof) of Formula (VI) as described above. The resulting monomers are of Formula (IV-2).

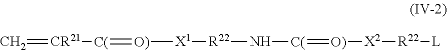

These monomers are of Formula (IV) where the variable n is equal to 1 and Z¹ is equal to —NH—C(═O)—X²—. The groups R²¹, R²², X¹, X², and L are the same as defined above.

Representative examples of ethylenically unsaturated isocyanates of Formula (VII) include 2-isocyanatoethyl (meth)acrylate (IEM or IEA), 3-isocyanatopropyl (meth)acrylate, 4-isocyanatocyclohexyl (meth)acrylate, and the like, and combinations thereof.

Representative examples of useful compounds of Formula (VI) that can provide an acidic L group (or salt thereof) include amino group-containing carboxylic, sulfonic, boronic, and phosphonic acids, and combinations thereof and/or salts thereof. Useful amino carboxylic acids include α-amino acids (L-, D-, or DL-α-amino acids) such as glycine, alanine, valine, proline, serine, phenylalanine, histidine, tryptophan, asparagine, glutamine, N-benzylglycine, N-phenylglycine, sarcosine, and the like; β-aminoacids such as β-alanine, homoleucine, homoglutamine, homophenylalanine, and the like; other α,ω-aminoacids such as γ-aminobutyric acid, 6-aminohexanoic acid, 11-aminoundecanoic acid, and the like; and combinations thereof. Useful amino sulfonic acids include aminomethanesulfonic acid, 2-aminoethanesulfonic acid (taurine), 3-amino-1-propanesulfonic acid, 6-amino-1-hexanesulfonic acid, and the like, and combinations thereof. Useful aminoboronic acids include m-aminophenylboronic acid, p-aminophenylboronic acid, and the like, and combinations thereof. Useful aminophosphonic acids include 1-aminomethylphosphonic acid, 2-aminoethylphosphonic acid, 3-aminopropylphosphonic acid, and the like, and combinations and/or salts thereof.

Representative examples of other useful compounds of Formula (VI) having an acidic L group (or salt thereof) include compounds including a hydroxy group and an acidic group. Specific examples include glycolic acid, lactic acid, 6-hydroxyhexanoic acid, citric acid, 2-hydroxyethylsulfonic acid, 2-hydroxyethylphosphonic acid, and the like, and combinations and/or salts thereof.

Still other representative compounds of Formula (VI) having an acidic L group (or salt thereof) are those that contain more than one acidic group include aspartic acid, glutamic acid, α-aminoadipic acid, iminodiacetic acid, N_{α},N_{α}-bis(carboxymethyl)lysine, cysteic acid, N-phosphonomethylglycine, and the like, and combinations and/or salts thereof.

Many of the above-described compounds of Formula (VI) that have an acidic L group (or salt thereof) are commercially available. Still other useful acidic group-containing compounds can be prepared by common synthetic procedures. For example, various diamines or aminoalcohols can be reacted with one equivalent of a cyclic anhydride to produce an intermediate acidic group-containing compound including a carboxyl group and an amino or hydroxy group.

In addition, useful monomers having an acidic group can be prepared by reaction of hydroxy- or amine-containing (meth)acrylate or (meth)acrylamide monomers with a cyclic anhydride to produce carboxyl group-containing monomers.

In certain embodiments, useful monomers of Formula (IV) having an L group that is an acidic group (or salt thereof) may be prepared from the reaction of alkenyl azlactones with aminocarboxylic acids, monomers prepared from the reaction of alkenyl azlactones with aminosulfonic acids, monomers prepared from the reaction of ethylenically unsaturated isocyanates with aminocarboxylic acids, monomers prepared from the reaction of ethylenically unsaturated isocyanates with aminosulfonic acids, or combinations thereof.

Some example monomers having a group L in Formula (IV) that is an acidic group or salt thereof are further described in U.S. Pat. No. 10,352,835 (Rasmussen et al.) and can include the following (many of which are shown as acids, but salts of such acids may also be used):

VDM-4-aminomethyl-cyclohexanecarboxylic acid

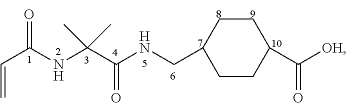 [SMILES: C=CC(=O)NC(C)(C)C(=O)NCC1CCC(C(=O)O)CC1]

VDM-2-hydroxy-4-aminobutanoic acid

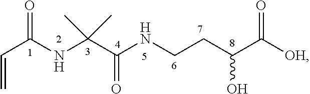 [SMILES: C=CC(=O)NC(C)(C)C(=O)NCCC(O)C(=O)O]

VDM-2-amino-3-hydroxypropanoic acid (VDM-serine)

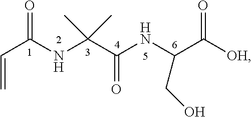 [SMILES: C=CC(=O)NC(C)(C)C(=O)NC(CO)C(=O)O]

VDM-2-amino-3-(4-hydroxyphenyl)propanoic acid (VDM-tyrosine)

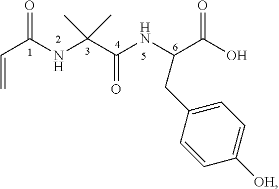 [SMILES: C=CC(=O)NC(C)(C)C(=O)NC(Cc1ccc(O)cc1)C(=O)O]

VDM-(2S)-2-amino-3-(1H-indol-3-yl)propanoic acid (VDM-tryptophan)

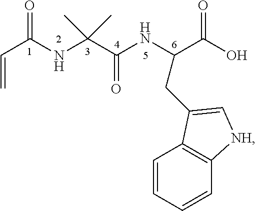 [SMILES: C=CC(=O)NC(C)(C)C(=O)NC(Cc1c[nH]c2ccccc12)C(=O)O]

VDM-7-aminoheptanoic acid

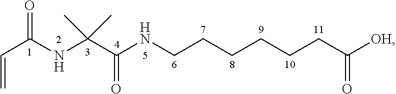 [SMILES: C=CC(=O)NC(C)(C)C(=O)NCCCCCCC(=O)O]

VDM-2-amino-3-(1H-imidazol-4-yl)propanoic acid (VDM-histidine)

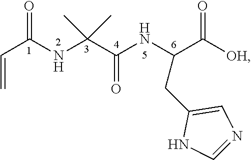 [SMILES: C=CC(=O)NC(C)(C)C(=O)NC(Cc1cnc[nH]1)C(=O)O]

IEM-3-aminopropanoic acid

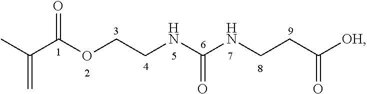 [SMILES: C=C(C)C(=O)OCCNC(=O)NCCC(=O)O]

### IEM-taurine

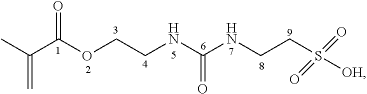 [SMILES: C=C(C)C(=O)OCCNC(=O)NCCS(=O)(=O)O]

### VDM-taurine

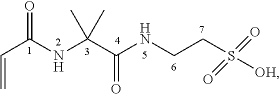 [SMILES: C=CC(=O)NC(C)(C)C(=O)NCCS(=O)(=O)O]

VDM-2-(hydroxyethyl)phosphonic acid

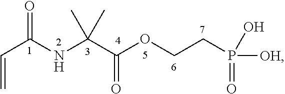 [SMILES: C=CC(=O)NC(C)(C)C(=O)OCCP(=O)(O)O]

VDM-3-aminopropanoic acid

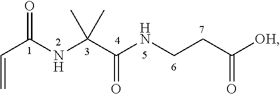 [SMILES: C=CC(=O)NC(C)(C)C(=O)NCCC(=O)O]

VDM-4-aminobutyric acid

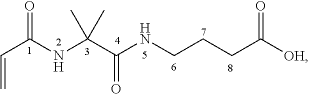 [SMILES: C=CC(=O)NC(C)(C)C(=O)NCCCC(=O)O]

VDM-5-aminovaleric acid

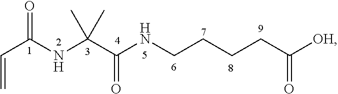 [SMILES: C=CC(=O)NC(C)(C)C(=O)NCCCCC(=O)O]

VDM-6-aminocaproic acid

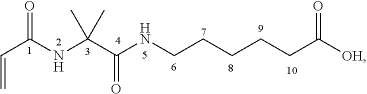 [SMILES: C=CC(=O)NC(C)(C)C(=O)NCCCCCC(=O)O]

### VDM-Phenylalanine

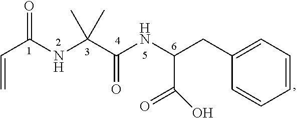 [SMILES: C=CC(=O)NC(C)(C)C(=O)NC(Cc1ccccc1)C(=O)O]

### IEM-Phenylalanine

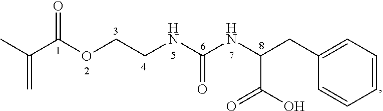 [SMILES: C=C(C)C(=O)OCCNC(=O)NC(Cc1ccccc1)C(=O)O]

### IEM-Glycine

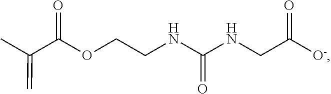

IEM-4-aminobutanoic acid (IEM-GABA)

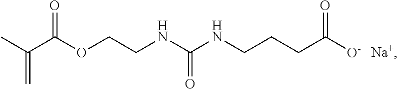

and
IEM-Aminomethylphosphonic acid

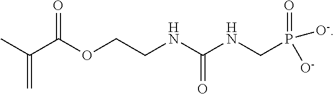

Representative examples of useful compounds of Formula (VI) that can provide a basic L group often contain at least one amino or hydroxy group and at least one basic group such as a tertiary or quaternary amino group. Specific examples include 2-(dimethylamino)ethylamine, 3-(diethylamino)propylamine, 6-(dimethylamino)hexylamine, 2-aminoethyltrimethylammonium chloride, 3-aminopropyltrimethylammonium chloride, 2-(dimethylamino)ethanol, 3-(dimethylamino)-1-propanol, 6-(dimethylamino)-1-hexanol, 1-(2-aminoethyl)pyrrolidine, 2-[2-(dimethylamino)ethoxy]ethanol, histamine, 2-aminomethylpyridine, 4-aminomethylpyridine, 4-aminoethylpyridine, and the like, and combinations thereof.

Some example monomers having a group L in Formula (IV) that is a basic group such as a tertiary or quaternary amino group are the following: VDM-2-aminoethyltrimethylammonium chloride

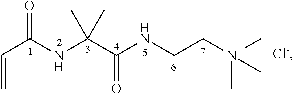 [SMILES: C=CC(=O)NC(C)(C)C(=O)NCC[N+](C)(C)C]

### IEM-diethylaminoethylamine

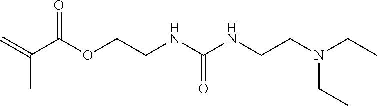 [SMILES: C=C(C)C(=O)OCCNC(=O)NCCN(CC)CC]

IEM-diisopropylaminoethylamine

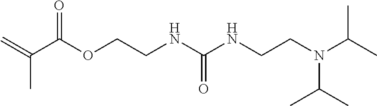 [SMILES: C=C(C)C(=O)OCCNC(=O)NCCN(C(C)C)C(C)C]

IEM-2-aminoethyltrimethylammonium chloride

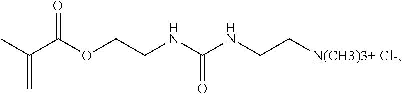

and
VDM adducts of dimethylaminoalkanols

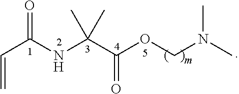

Some monomers of Formula (IV) have an L group that is a guanidino or biguanidino group. That is, L is of formula —NR²⁴—[C(═NR²⁴)—NR²⁴]ₘR²⁵ where m is 1 or 2. When m is equal to 1, group L is a guanidino group and when m is equal to 2, group L is a biguanidino group. Group R²⁴ is hydrogen or hydrocarbyl and group R²¹ is hydrogen, hydrocarbyl, or —N(R²⁴)₂. Suitable hydrocarbyl groups for R²⁴ and R²⁵ are often aryl or alkyl groups. In many embodiments, R²⁴ and/or R²⁵ are hydrogen. Such monomers can be prepared as described in PCT Patent Applications WO 2014/204763 (Rasmussen et al.) and WO 2013/184366 (Bothof et al.).

Monomers with guanidino or biguanidino groups can be prepared, for example, by reaction of a (meth)acryloyl halide (e.g., (meth)acryloyl chloride), a (meth)acryloyl isocyanate (as in Formula (VI) above), or an alkenyl azlactone (as in Formula (V) above) with a compound of Formula (VIII).

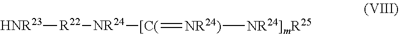

The compounds of Formula (VIII) correspond to compounds of Formula (VI) where X² is —NR²³— and L is —NR²⁴—[C(═NR²⁴)—NR²⁴]ₘR²⁵. These compounds can be formed by reaction of a diamine with a guanylating agent as described, for example, in PCT Patent Application WO 2014/204763 (Rasmussen et al.). The groups R²², R²³, R²⁴, and R²⁵ plus the variable m are the same as described above. Some compounds of Formula (VIII) are available commercially, for example, 4-aminobutylguanidine (agmatine).

When the compound of Formula (VIII) is reacted with an alkenyl azlactone, a monomer of Formula IV-3 is formed.

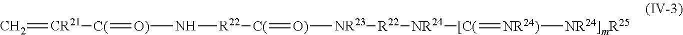

This monomer is of Formula (IV) where n is equal to 1, Z¹ is —C(═O)—NR²³—, and X¹ is —NH—. The groups R²¹, R²², R²³, R²⁴, and R²⁵ plus the variable m are the same as described above.

When the compound of Formula (VIII) is reacted with (meth)acryloyl isocyanate, a monomer of Formula (IV-4) is formed.

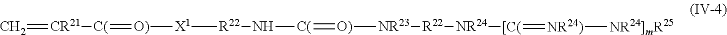

This monomer is of Formula (IV) where n is equal to 1, Z¹ is —NH—C(═O)—NR²³—, L is of formula —NR²⁴—[C(═NR²⁴)—NR²⁴]ₘR²⁵. The groups R²¹, R²², R²³, R²⁴, and R²⁵ plus the variable m are the same as described above.

Some specific examples of the first monomer having a guanidino group for L are shown below. The structures are shown as neutral compounds for simplicity but can be present as various salts such as, for example, chloride salts or sulfate salts:

2-({[(4-[amino(imino)methyl]aminobutyl)amino]carbonyl}-amino)ethyl methacrylate

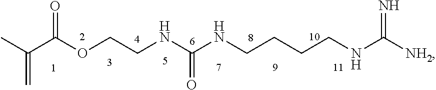 [SMILES: C=C(C)C(=O)OCCNC(=O)NCCCCNC(=N)N]

N²-acryloyl-N¹-(4-{[amino(imino)methyl]amino}butyl)-2-methylalaninamide

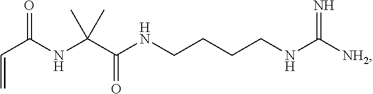 [SMILES: C=CC(=O)NC(C)(C)C(=O)NCCCCNC(=N)N]

N²-acryloyl-N¹-(6-{[amino(imino)methyl]amino}hexyl)-2-methylalaninamide

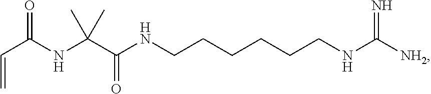 [SMILES: C=CC(=O)NC(C)(C)C(=O)NCCCCCCNC(=N)N]

and 2-({[N-(2-[amino(imino)methyl]aminoethyl)-N-benzylamino]carbonyl}-amino)ethyl methacrylate

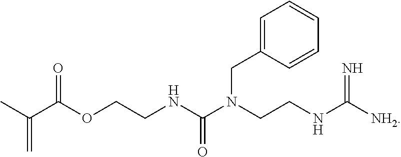 [SMILES: C=C(C)C(=O)OCCNC(=O)N(CCNC(=N)N)Cc1ccccc1]

The above-described first monomers can be homopolymerized to provide the first polymeric block. In other embodiments, various first monomers can be combined and copolymerized. In still other embodiments, other types of monomers can be combined with the first monomer and copolymerized.

The first polymeric block is often a homopolymer of the acidic monomer or the basic monomer to prepare block copolymers with high binding capacity for the materials desired to be captured. That is, the first polymeric block can be up to 100 weight percent of acidic monomeric units or salts thereof, basic monomeric units or salts thereof, or combinations (mixtures) thereof. In some embodiments, other monomers (second monomers) are copolymerized with the first monomers to adjust the binding capacity and/or to achieve other desired properties of the first polymeric block. Any suitable second monomer can be used.

The amount of the first monomer that has an acidic or basic group can be, for example, in a range of 50 to 100 weight percent acidic or basic monomeric units based on the total weight of monomeric units in the first polymeric block. The amount can be at least 50, at least 60, at least 70, at least 75, at least 80, at least 85, at least 90, or at least 95 and up to 100, up to 99, up to 98, up to 97, up to 95, up to 90, up to 85, up to 80, or up to 75 weight percent based on the total weight of monomeric units in the first polymeric block. Higher amounts of the first monomer tend to increase the binding capacity for various target compounds such as biomaterials. In many embodiments, the amount of the first monomer that is an acidic group, basic group, or salt thereof is in a range of 80 to 100, 85 to 100, 90 to 100, or 95 to 100 weight percent based on the total weight of monomeric units.

The second monomer in the first polymeric block can be, for example, a hydrophilic monomer to adjust the degree of hydrophilicity imparted to the substrate. The hydrophilic monomer has an ethylenically unsaturated group and a hydrophilic group such as, for example, hydroxyl group, or amido group. Suitable hydrophilic monomers include acrylamide, dimethylacrylamide, hydroxyethyl(meth)acrylate, hydroxypropyl(meth)acrylate, ethoxyethylmethacrylate, diethyleneglycolmethylether methacrylate, 2-hydroxyethylacrylamide, N-vinylpyrrolidone, and the like, and combinations thereof.

Other second monomers in the first polymeric block include those that have more than one ethylenically unsaturated groups. This types of second monomers are typically used in only relatively small amounts to impart a degree of branching and/or relatively light crosslinking to a resulting copolymer. For example, the amount of these multifunctional monomers having more than two ethylenically unsaturated groups may be present in an amount ranging from 0.1 to 5 weight percent, based upon the total weight of monomers in the first polymerizable composition. The amount can be at least 0.1, at least 0.2, at least 0.5, or at least 1.0 weight percent and up to 5, up to 4, up to 3, up to 2, or up to 1 weight percent. Higher amounts can be used for certain applications, but higher amounts may reduce binding capacity for various biomaterials.

The total amount of the second monomer can be up to 50 weight percent of the monomers used to form the first polymeric block. Lower amounts of the second monomer typically enhance the binding capacity for various target compounds such as biomaterials. The amount, if present, is usually equal to 100 minus the weight percent of the first monomer based on the total weight of monomers in the first polymerizable composition.

The first polymeric block often has a graft density of about 0.02 to about 3 mmoles/gram or even higher. The graft density can be at least 0.02, at least 0.05, at least 0.1, at least 0.2, at least 0.5, or at least 1 mmoles/gram and up to 3, up to 2.5, up to 2, up to 1.5, up to 1, up to 0.8, up to 0.7, or up to 0.5 mmoles/gram. This corresponds to a weight gain of 1 to 85 percent or higher. The weight gain is calculated from the equation [100 (Weight 2−Weight 1)÷Weight 1] where Weight 1 is the weight of the substrate and Weight 2 is the weight of the substrate with grafted polymers attached. The weight gain can be in a range of 1 to 85 weight percent or even higher. The amount, can be, for example, at least 1, at least 2, at least 5, at least 10, at least 15, at least 20, at least 25, at least 30, at least 35, at least 40, at least 45, or at least 50 weight percent and up to 85, up to 80, up to 75, up to 70, up to 65, up to 60, up to 55, up to 50, up to 45, up to 40, up to 35, or up to 30 weight percent.

Regardless of whether Grafting Method 1 or Grafting Method 2 is used to form the first polymeric block, a thiocarbonylthio-containing compound is usually added to the first reaction mixture. Although its addition is optional, the presence of the thiocarbonylthio-containing compound can increase the likelihood that the terminal group of the first polymeric block is a thiocarbonylthio-containing group. The presence of this group is needed to initiate formation of the second polymeric block. The amount of the thiocarbonylthio-containing compound can range from 0 to 20 weight percent for Grafting Method 1 and 0.5 to 20 weight percent for Grafting Method 2. The amount for Grafting Method 1 is often at least 0, at least 0.1, at least 0.2, at least 0.3, at least 0.5, at least 1, at least 2, at least 3, at least 4 or at least 5 weight percent and up to 20, up to 15, up to 10, up to 8, up to 6, up to 5, up to 4, up to 3, or up to 2 weight percent. The amount for Grafting Method 2 is often at least 0.5, at least 1, at least 2, at least 3, at least 4 or at least 5 weight percent and up to 20, up to 15, up to 10, up to 8, up to 6, up to 5, up to 4, up to 3, or up to 2 weight percent. If a thiocarbonyl-thio compound is added with Grafting Method 1, it can be the same or different than the thiocarbonylthio-containing compound that was bonded to the surface of the polymeric substrate to form a modified substrate.

The presence of the thiocarbonylthio-containing compound in the reaction mixture can initiate the formation of polymers that are not attached to the substrate. These polymers that are not bonded to the substrate are typically removed after formation of the article so that the only polymers remaining are those covalently attached to the porous polymeric substrate.

As indicated above, in some alternative grafting methods, a thiocarbonylthio-containing compound is absent and the covalently attached first polymeric block is terminated with a semi-pinacol group. In these alternatives, the terminal semi-pinacol group functions as the RDRP group that initiates the formation of the second polymeric block.

### Forming Second Polymeric Block Attached to First Polymeric Block

A second polymeric block is formed that is covalently attached to the first polymeric block with the first polymeric block positioned between the second polymeric block and the porous polymeric substrate. The resulting block copolymer extends away from the surface of the porous polymeric substrate. Although additional polymeric blocks can be added, the grafted block copolymer is typically a diblock polymer.

Regardless of the method used to form the first polymeric block, at least some of the chain ends of that block are terminated with RDRP agents, such as, for example, with thiocarbonylthio-containing groups or semi-pinacol groups. As such, the chain termini of the first polymeric block can function as an initiator for the second polymeric block. Typically, the substrate comprising the grafted first polymeric block is coated with the second polymerizable composition comprising a polyether monomer having at least one ethylenically unsaturated group and a polyether group. The RDRP agent is then activated, for example, by actinic radiation, to regenerate a free radical chain end and a radical derived from the RDRP agent. The radical chain end then initiates polymerization of the second monomer composition, forming the second polymeric block. Finally, termination can occur by recombination with the radical derived from the RDRP agent or by any of the other well-known radical termination mechanisms.

The second polymeric block is a reaction product of a second polymerizable composition comprising a polyether monomer having at least one ethylenically unsaturated group and a polyether group. The polyether monomers are typically selected to be hydrophilic or water swellable. Suitable polyether monomers, regardless of the number of ethylenically unsaturated groups, usually contain a plurality of ethylene oxy groups, propylene oxy groups, or a mixture thereof. The number of ethylenically unsaturated groups are usually in a range of 1 to 4 such as 1 to 3 or 1 to 2.

The second polymeric block is formed to provide a porous polymeric network that can be used to separate materials in a sample based on size or steric effects. That is, the second polymeric block can prevent or reduce the number of larger materials that can interact with the acidic and/or basic groups on the first polymeric block. In most embodiments, the second polymeric block is crosslinked. However, if the polyether groups are sufficiently long and/or entangled, crosslinking may be optional.

Any suitable approach can be used to crosslink the second polymeric block. In some embodiments, crosslinking occurs by using polyether monomers that have a plurality of ethylenically unsaturated groups in the second polymerization composition. Any amount of these polyether monomers can be used to obtain the desired porosity for the second polymeric block.

In some embodiments, all the polyether monomers in the second polymerizable composition have at least two ethylenically unsaturated groups. All these polyether monomers can have the same weight average molecular weight and the same number of ethylenically unsaturated groups or there can be a mixture of different polyether monomers that have different weight average molecular weights and/or different numbers of ethylenically unsaturated groups.

In other embodiments, the second polymerizable composition includes a mixture of polyether monomers having a single ethylenically unsaturated group and polyether monomers having a plurality of ethylenically unsaturated groups. The size of the polyether monomers in the mixture can be the same or different. The amount of the polyether monomers having a plurality of ethylenically unsaturated groups can be varied to obtain the desired porosity of the polymeric network.

In still other embodiments, the second polymerizable composition further includes a crosslinking monomer that is not a polyether monomer. The crosslinking monomer is selected to be water soluble and can be combined with polyether monomers that have a single ethylenically unsaturated group, a plurality of ethylenically unsaturated groups, or a mixture thereof. The amount of the crosslinking monomer can be varied to obtain the desired porosity of the polymeric network.

The weight average molecular weight of the polyether monomer is often in a range of 250 to 20,000 Daltons. The weight average molecular weight can be at least 300, at least 400, at least 500, at least 700, at least 800, at least 1000, at least 2000, at least 5000 and up to 20,000, up to 10,000, up to 5000, up to 2000, or up to 1000 Daltons.

Suitable polyether monomers with one or more ethylenically unsaturated groups are commercially available from Aldrich Chemical, Milwaukee, WI, USA such as, for example, polyethylene glycol diacrylate (PEGDA) having a number average molecular weight of 302, 575, 2000, 6000, and 10,000 Daltons as well as poly(ethylene glycol) methyl ether methacrylate (PEGMA) having a number average molecular weight of 200, 400, and 2000 Daltons. Other suitable polyether monomers are commercially available from Sartomer, Exton, PA, USA such as, for example, those having the trade designation SR415 (ethoxylated (20) trimethylolpropane triacrylate), SR610 (polyethylene glycol diacrylate with an average molecular weight of 600 Da), SR9035 (ethoxylated (15) trimethylolpropane triacrylate), and SR9038 (ethoxylated (30) bisphenol A diacrylate).

If a crosslinking monomer is used that is not a polyether monomer, the weight average molecular weight is often in a range of 100 to 500 Daltons. The weight average molecular weight can be at least 100, at least 150, or at least 200 and up to 500, up to 450, up to 400, up to 350, or up to 300 Daltons. Examples include, but are not limited to, methylenebisacrylamide, 3-acryloyloxy-2-hydroxypropyl methacrylate, glyceroldimethacrylate, glyceroldiacrylate, diacryloylpiperazine, and 1,2-ethylenebisacrylamide.

The second polymeric block often has a graft density in a range of about 0.01 to about 1 mmoles/gram or even higher. The graft density can be at least 0.01, at least 0.02, at least 0.05, at least 0.1, at least 0.2, at least 0.3, or at least 0.5 mmoles/gram and up to 1 or even higher, up to 0.8, up to 0.7, up to 0.6, up to 0.5, or up to 0.4 mmoles/gram. This corresponds to a weight gain of 0.2 to 90 percent or even higher. The weight gain is calculated from the equation [100 (Weight 3−Weight 2)÷Weight 2] where Weight 2 is the weight of the substrate plus the attached first polymeric block and Weight 3 is the weight of the substrate with the attached block copolymer (both the first and second polymeric block) attached. The weight can be in a range of 0.2 to 90 weight percent or even higher. The amount, can be, for example, at least 0.2, at least 0.5, at least 1, at least 2, at least 5, at least 10, at least 15, at least 20, at least 25, at least 30, at least 35, at least 40, at least 45, or at least 50 weight percent and up to 90, up to 85, up to 80, up to 75, up to 70, up to 65, up to 60, up to 55, up to 50, up to 45, up to 40, up to 35, or up to 30 weight percent.

### Method of Separating Mixtures of Materials

The separation articles can be used to separate various mixture of materials such as, for example, mixtures of biomaterials. As described above, the separation articles have a block copolymer grafted to a porous polymeric substate. The block copolymer contains a first polymeric block with acidic monomeric units, basic monomeric units, or a combination thereof that can bind to various biomaterials. These monomeric units can be in the form of salts depending the on the pH. The block copolymer further contains a second polymeric block that can separate biomaterials based on size or steric parameters. The method of separation includes preparing the separation article as described above and then passing a mixture of materials through the separation article, wherein the second polymeric block allows only a portion of the materials in the mixture to contact the acid groups or salts thereof, basis groups or salts thereof, or a combination thereof in the first polymeric block.

As used herein, the term “portion” refers to the fact that some of the components (i.e., materials) of the mixture are restricted from accessing the first block by the presence of the second block. That restricted access can be observed as a reduction in binding capacity for the component upon addition of the second block. Typically, the larger components of the mixture are the ones most restricted, and the smaller components can still diffuse through the second block and bind to the first block, thus allowing a selective separation of large and small components. The separation can be 100% selective, for example a smaller component of the mixture may be completely captured by the first polymeric block and removed by the separation device while the larger component flows through the device (e.g., excluded by the second polymeric block from being captured by the first polymeric block) and is recovered in 100 percent purity and yield. Alternatively, the separation may be less than 100 percent selective and result in only partial removal of a component or components from the mixture. Typical chromatographic manipulations, such as buffer and pH adjustments, flow rates, residence times, etc., may be used to optimize the selectivity of the separation.

The portion can be any suitable amount. In some embodiments, the portion of material passing through the second polymeric block to reach the first polymeric block is at least 1 weight percent based on a total weight of the material being separated. The amount can be at least 2, at least 5, at least 10, at least 20, at least 30, at least 40, at least 60, at least 70, at least 80, or at least 90 weight percent or even more based on a total weight to material being separated.

While not wanting to be bound by theory, it is believed that the ability of the separation articles to provide selective separations is based on at least one of (a) manipulation of the pore size of the second polymeric block, (b) steric exclusion derived from the presence of polyether chains in the second polymeric block, or (c) a combination of both.

Engberg, et al., Biomed. Mater., 6 (2011), 055006 reports that the diffusion coefficient of proteins in crosslinked polyethylene glycol diacrylate (PEGDA) hydrogels is inversely related to the concentration of the PEGDA when the crosslinking reaction is initiated. An increased concentration results in a more tightly crosslinked hydrogel, thus decreasing the pore size and slowing protein diffusion. Alternatively, increasing the molecular weight of the PEGDA increases the distance between crosslinks, thus increasing the pore size of the hydrogel. Consequently, in the separation articles described herein, access of materials to the first polymeric block can be optimized by manipulation of the molecular weight of the polyether monomer and its concentration during formation of the second polymeric block.

The attachment of hydrophilic polymers, such as those derived from a polyether-containing monomer, to surfaces to render them anti-fouling or protein repellent is well known. This phenomenon is at least partially due to steric exclusion, in which the presence of the polyether group results in preferential hydration of the protein, leading to a mutual repulsion between the two species. This repulsive interaction is known to increase with increasing molecular weight of the polyether monomer (see Bhat, et al., Protein Science, 1 (1992), pp. 1133-1143). While the thickness of the hydration shell is somewhat protein dependent, this can influence the effective size of the protein and its ability to penetrate the hydrogel. Thus, steric exclusion effects may be modulated by choice of the polyether monomer used for the second polymeric block.

In addition to the choice of the polyether monomer and its concentration in the second polymeric block, the graft densities of the first and second polymeric blocks can be altered to optimize the separation selectivity of the separation articles. Increasing the graft density of the first polymeric block typically increases the binding capacity of that block. Increasing the graft density of the second polymeric block, thus increasing its thickness, typically improves the selectivity of the block copolymer. Finally, control of the overall graft density allows for control of the flow properties of the separation article.

As indicated above, the separation articles are advantageously prepared using thiocarbonylthio-containing compounds as RDRP agents. In some instances, these agents may offer better control over the selective separations than can be achieved when using other RDRP agents, such as for example semi-pinacol-containing agents. In other words, it has been found that finer control over size selectivity may be achieved using the thiocarbonylthio-containing RDRP agents. In some embodiments using thiocarbonylthio-containing RDRP agents, separation articles can be prepared that will capture small biomolecules, such as lysozyme, a 14.3 kD protein, while completely or almost completely excluding larger proteins such as IgG, a 150 kD protein. This allows separation of the small protein from the large protein even though they both are positively charged at neutral pH. One example where this selectivity can be advantageous is monoclonal antibody purification in a flow through separation device.

In other embodiments, such as by using semi-pinacol-containing RDRP agents, the selectivity between large and small proteins may not be quite as good compared to using thiocarbonylthio-containing RDRP agents. However, for separating larger biotherapeutics, such as virus-like particles or viral vectors, from smaller biomaterials, such as host cell proteins, the separation article may advantageously be prepared using a somewhat simpler and less expensive semi-pinacol-containing RDRP agent. One example where this selectivity would be advantageous is for capturing or removing protein impurities from production streams of viral vectors or virus-like particles in a flow through separation device.

The separation articles can be used for the separation of a variety of mixtures of material such as, for example, mixtures of biomaterials. Example separations that can occur with biomaterials include, but are not limited, to the following: (1) separation of monoclonal antibodies (mAbs) from host cell protein (HCP) impurities, (2) separation of mAbs from antibody fragments, (3) separation of mAbs from higher molecular weight antibody aggregates, (4) separation of bispecific antibodies (biAbs) from antibody fragments, (5) separation of antibody-drug conjugates (ADCs) from unconjugated drugs, (6) separation of Fc-fusion proteins from Fc-fusion protein fragments, (7) separation of IVIG antibodies (gamma globulins) from smaller blood plasma proteins, (8) separation of milk proteins based on size and/or charge, e.g., lactoferrin, α-lactalbumin, β-lactoglobulin, (9) separation of viral vectors, viruses, or virus-like particles from host cell impurities such as HCPs and nucleic acids, and (10) separation of nucleic acids from other nucleic acids or other impurities (e.g., mRNA from its plasmid DNA template, mRNA from DNA fragments, or plasmid DNA from enzymes, DNA fragments, and other impurities).

As stated above, the separation articles can be used to separate various materials such as biomaterials based on size or steric parameters. For example, biomaterials being captured by the first polymeric block are generally smaller in size than the biomaterials that are excluded by the second polymeric block, and thus diffuse through the second polymeric block to interact with and bind to the first polymeric block. The biomaterials bound to the first polymeric block typically have an ionic charge that is opposite that of the first polymeric block, such that the binding interaction is an ion exchange type of interaction. The binding interaction may be exclusively of the ion exchange type, or it may be enhanced by other secondary types of interactions, such as hydrogen-bonding or hydrophobic or metal affinity type interactions, depending upon the structure of the monomer used to form the first polymeric block. The bound biomaterials may have a similar net charge or an opposite net charge as the biomaterials that they are being separated from by the second polymeric block. Clearly, the separation method is most advantageous when being used to separate materials having similar charge characteristics. The bound biomaterials may be impurities that are desirably removed from the mixture. Alternatively, they may be the object of the purification in that, once bound, the impurities may be washed away, then the buffer conditions (pH, conductivity, etc.) may be changed so as to elute the bound biomaterial in a purified form.

### EXAMPLES

Materials

| Abbreviation | Description and source |
|---|---|
| Nylon membrane | Nylon 66 membrane, single reinforced layer nylon three-zone |
| | membrane, nominal pore size 0.8 μm, #080ZN, obtained from 3M |
| | Separation and Purification Sciences, St. Paul, MN |
| PEGDA 575 | Polyethylene glycol diacrylate, average molecular weight 575 Daltons, |
| | equivalent weight 288, obtained from Aldrich Chemical, Milwaukee, WI |
| PEGDA 302 | Polyethylene glycol diacrylate, average molecular weight 302 Daltons, |
| | equivalent weight 151, obtained from Aldrich Chemical, Milwaukee, WI |
| PEGDA 2000 | Polyethylene glycol diacrylate, average molecular weight 2000 Daltons, |
| | obtained from Aldrich Chemical, Milwaukee, WI |
| PEGDA 6000 | Polyethylene glycol diacrylate, average molecular weight 6000 Daltons, |
| | obtained from Aldrich Chemical, Milwaukee, WI |
| PEGDA 10000 | Polyethylene glycol diacrylate, average molecular weight 10000 |
| | Daltons, obtained from Aldrich Chemical, Milwaukee, WI |
| AMPS | 2-Acrylamido-2-methylpropane sulfonic acid, obtained from Lubrizol |
| | Corporation, Wickliffe, OH under the trade designation AMPS 2404 |
| PEGDA 600 | Polyethylene glycol 600 diacrylate, molecular weight 742 Daltons, |
| | obtained from Sartomer, Exton, PA under the trade designation SR610 |
| SR415 | Ethoxylated (20) trimethylolpropane triacrylate, obtained from Sartomer, |
| | Exton, PA |
| SR9035 | Ethoxylated (15) trimethylolpropane triacrylate, molecular weight 956 |
| | Daltons, obtained from Sartomer, Exton, PA |
| SR9038 | Ethoxylated (30) bisphenol A diacrylate, molecular weight 1656 |
| | Daltons, obtained from Sartomer, Exton, PA |
| HEMA | 2-Hydroxyethyl methacrylate, obtained from Aldrich Chemical, |
| | Milwaukee, WI |
| MBA | Methylene bisacrylamide, obtained from Aldrich Chemical, Milwaukee, |
| | WI |
| PEGMA 200 | Poly(ethylene glycol) methyl ether methacrylate, average molecular |
| | weight 280 Daltons, obtained from Aldrich Chemical, Milwaukee, WI |
| PEGMA 400 | Poly(ethylene glycol) methyl ether methacrylate, average molecular |
| | weight 480 Daltons, obtained from Aldrich Chemical, Milwaukee, WI |
| PEGMA 2000 | Poly(ethylene glycol) methyl ether methacrylate, average molecular |
| | weight 2000 Daltons, obtained from Aldrich Chemical, Milwaukee, WI |
| AOHPMA | 3-Acryloyloxy-2-hydroxypropyl methacrylate, obtained from Aldrich |
| | Chemical, Milwaukee, WI |
| MAPTAC | Methacrylamidopropyltrimethylammonium chloride, obtained from |
| | Aldrich Chemical, Milwaukee, WI |
| IEM/Agmatine | Monomer prepared from isocyanatoethyl methacrylate and agmatine |
| | sulfate, as described in U.S. Patent 10,144,760, Example 99 |
| IEM/GABA | Monomer prepared from isocyanatoethyl methacry late and γ- |
| | aminobutyric acid, as described in U.S. Pat. No. 10,352,835, Preparative |
| | Example 3 |
| IEM/Glycine | Monomer prepared from isocyanatoethyl methacrylate and glycine, as |
| | described in U.S. Pat. No. 10,352,835, Preparative Example 12 |
| VDM/GABA | Monomer prepared from vinyldimethylazlactone and y-aminobutyric |
| | acid, as described in U.S. Pat. No. 10,352,835, Preparative Example 14 |
| EXA | Ethylxanthoylacetate, sodium salt, also called 2-ethoxycarbothioyl- |
| | sulfanylacetate, sodium salt, prepared as described in U.S. Patent |
| | Application 2021/0095088 |
| DEX | Diethylbisxanthate, also called dixanthogen, prepared as described in |
| | U.S. Patent Application 2021/0095088 |
| MEX | Methyl ethylxanthoylacetate, also called methyl 2- |
| | ethoxycarbothioylsulfanyl-acetate, prepared as described in U.S. Patent |
| | Application 2021/0095088 |
| Sodium 3- | Type II photoinitiator, prepared from 3-carboxybenzophenone, obtained |
| carboxybenzophenone | from Sigma-Aldrich, Milwaukee, WI, by dissolution in an equivalent of |
| | IN NaOH and diluted with deionized water to a concentration of 0.033 g/mL |

### Test Methods

### Protein Binding Capacity Method for Functionalized Substrates

First grafted substrates and second grafted substrates prepared as described in the Examples below were analyzed for protein binding capacity by incubating one disk of the substrate in a solution of a test analyte (protein dissolved in an appropriate binding buffer) overnight. The disk was prepared by die-punching an 18-mm diameter disk from a sheet of the grafted substrate. Each disk was placed in a 5 mL centrifuge tube with 4.5 mL of test analyte solution. The tubes were capped and tumbled overnight (typically 14 hours) on a rotating mixer (BARNSTEAD/THERMOLYN LABQUAKE Tube Shaker, obtained from VWR International, Eagan, MN; Thermo Scientific Tube Revolver Rotator, obtained from Thermo Scientific, Waltham, MA). The supernatant solutions were discarded, the tubes were filled with binding buffer and tumbled for 15-30 minutes to wash off excess protein solution. The supernatant solutions were discarded, and the buffer wash was repeated two more times. Bound protein was eluted by adding 4.5 mL of binding buffer containing 1 M NaCl and tumbling for 1 hour. The eluted supernatant solutions were analyzed using a UV-VIS spectrometer (Agilent 8453, Agilent Technologies, Santa Clara, CA) at 280 nm (with background correction applied at 325 nm) or using a NANODROP One^{C} Microvolume UV-VIS Spectrophotometer (Thermo Scientific, Waltham, MA). The binding capacity for each substrate was determined from the UV absorbance and the protein extinction coefficient provided by the supplier. Results are reported in mg/mL (mg of protein bound/mL of substrate volume) as the average of three replicates.

### Test Analyte Solutions (Protein in Binding Buffer, Unless Otherwise Stated in the Examples Below)

| Protein | Test analyte solution |
|---|---|
| Lysozyme | Chicken egg white lysozyme (Sigma-Aldrich Corporation, St. Louis, MO), at |
| | a concentration of about 3.5 mg/mL in a binding buffer that is 10 mM MOPS |
| | (4-morpholinopropanesulfonic acid; Sigma-Aldrich, St. Louis, MO) at pH 7.0. |
| IgG | Human IgG (Sigma-Aldrich Corporation, St. Louis, MO), at a concentration |
| | of about 3.0 mg/mL in a binding buffer that is 50 mM HEPES ((4-(2- |
| | hydroxyethyl)-1-piperazineethanesulfonic acid); Sigma-Aldrich, St. Louis, |
| | MO) at pH 7.0. |
| β-Lactoglobulin | β-lactoglobulin from bovine milk (Sigma-Aldrich Corporation, St. Louis, |
| | MO), at a concentration of about 3 mg/mL in a binding buffer that is 50 mM |
| | HEPES at pH 7.0. |
| BSA | Bovine serum albumin (Sigma-Aldrich Corporation, St. Louis, MO), at a |
| | concentration of about 3 mg/mL in a binding buffer that is 50 mM HEPES at |
| | pH 7.0. |

### Graft Density

Substrates (membranes, nonwoven webs, or first grafted substrates) were equilibrated for a minimum of 18 hours in a low humidity chamber (Sanpia Dry Keeper, Sanplatec Corporation, available from VWR International) at a relative humidity (RH) of 20-25 percent (%), prior to being grafted. The substrates were removed from the low humidity chamber, weighed immediately, and then subjected to a free radical grafting reaction (i.e., Grafting Procedure) as described below. Following a washing and drying process (as described below), the substrates were again equilibrated in the low humidity chamber for a minimum of 18 hours, removed from the chamber, and reweighed immediately to obtain a measurement of mass gain during the grafting reaction. The mass gain was subsequently utilized to estimate the number of millimoles of monomeric units grafted to the substrate by dividing the mass gain by the molecular weight of the monomer. Graft density was then normalized by dividing by the original mass of the substrate and expressed as millimoles of monomeric units grafted per gram of substrate (mmol/g).

### Membrane Coating Procedure

Coating solutions comprising monomer were prepared as described below. For each coating solution, a membrane substrate was placed on a sheet of polyester film, and sufficient coating solution was pipetted onto the top surface of the substrate to completely wet the membrane substrate. The coating solutions are described in Procedures A to E below for formation of the first grafted substrate (i.e., first polymeric block grafted to substrate). Each coating solution was allowed to soak into the membrane substrate for about 1 minute, and then a second sheet of polyester film was placed on top of the substrate. A 2.28 kg cylindrical weight was rolled over the top of the resulting three-layer sandwich to squeeze out excess coating solution. Coating solutions for formation of the second grafted substrate are described in individual Examples.

### Nonwoven Coating Procedure

Coating solutions comprising monomer were prepared as described below. For each coating solution, a nonwoven sheet was placed inside of plastic bag with closure, and sufficient coating solution was pipetted onto the top surface of the nonwoven substrate to completely wet the nonwoven substrate. A cylindrical weight (2.28 kg) was rolled over the top of the bag to distribute the fluid throughout the web (i.e., nonwoven substrate). The plastic bag was purged with nitrogen gas for 10 seconds and closed the filled plastic bag to ensure the coated web was in an environment lacking oxygen. The plastic bag was slightly opened and immediately rolled with the cylindrical weight to evacuate the gas from the bag, flatten the plastic bag, and squeeze out excess coating solution. The coating solutions are described in Procedures F and G below for formation of the first grafted substrate (i.e., first polymeric block grafted to substrate). Coating solutions for formation of the second grafted substrate are described in individual Examples.

### Ultraviolet (UV)-Initiated Grafting Procedure

Ultraviolet (UV)-initiated grafting was conducted by irradiating the coated membrane in a polyester film sandwich or the coated nonwoven in a plastic bag with closure using a UV stand (Classic Manufacturing, Inc., Oakdale, MN) equipped with 18 bulbs (Sylvania RG2 40 W F40/350BL/ECO, 10 above and 8 below the substrate, 1.17 meters (46 inches) long, spaced 5.1 cm (2 inches) on center), with an irradiation time as indicated below in Procedures A to G and Examples 1 to 60. The membrane or nonwoven sheets were removed, and the resulting first grafted substrate was placed in a polyethylene bottle for washing as described below. After washing and drying, the first grafted substrate was tested for graft density and protein binding capacity.

These same conditions were used to form and characterized the second grafted substrate unless described differently below.

### Formation of First Grafted Substrate (i.e., First Polymeric Block Grafted to Substrate)

### Procedure A

Coating solutions, 20 mL total volume, were prepared containing 0.5M, 0.75M, LOM, 1.25M, or 1.5M AMPS, sodium salt of 3-carboxybenzophenone (Aldrich Chemical, Milwaukee, WI) (2.0 mL of a 0.033 g/mL aqueous solution), and DEX (140 μL) in methanol. The solutions were coated onto nylon membrane sheets (8″×8″) and UV grafted by the above UV-Initiated Grafting Procedure for 15 or 30 minutes to generate a grafted cation exchange first polymeric block derived from AMPS and terminated with ethoxythiocarbonylthio groups. After washing with 0.9% saline, methanol, 0.9% saline, methanol (2 more times), 30 minutes each, and drying the sheet, mass gains were measured to determine graft density (Table 1). Subsequently, sections of each sheet were cut for evaluation or for grafting of a second polymeric block.

TABLE 1
First Grafted Substrates A1 to A6

| First | UV | AMPS | Graft |
|---|---|---|---|
| Grafted | Irradiation Time | Concentration | Density |
| Substrate | (minutes) | (M) | (mmol/g) |
| A1 | 15 | 0.5 | 0.05 |
| A2 | 15 | 0.75 | 0.18 |
| A3 | 15 | 1.0 | 0.28 |
| A4 | 15 | 1.25 | 0.42 |
| A5 | 15 | 1.5 | 0.47 |
| A6 | 30 | 1.0 | 0.42 |

### Procedure B

A coating solution was prepared by mixing AMPS 10.35 grams), a 1% wt/wt solution of benzophenone (Aldrich Chemical, Milwaukee, WI) in methanol (12 mL), DEX (280 μL), methanol (17.65 mL), and deionized water (3 mL). This solution was approximately 1.16 M in AMPS. It was coated onto two nylon membrane sheets (8″×8″) and UV irradiated by the above UV-Initiated Grafting Procedure for 30 minutes to generate membranes grafted with a first polymeric block having monomeric units derived from AMPS and terminated with ethoxythiocarbonylthio groups. After washing as described in Procedure A and drying, membranes B1 and B2 had mass gains of 4.9 and 5.7% respectively, corresponding to graft densities of 0.21 and 0.25 mmol/g, respectively.

### Procedure C

A coating solution identical to that used for membrane A4 in Table 1 was prepared and used to graft two nylon membrane sheets (8″×8″), UV irradiated by the above UV-Initiated Grafting Procedure for 30 minutes, to generate membranes with a grafted first polymer derived from AMPS and terminated with ethoxythiocarbonylthio groups. The membranes were washed three times with deionized water only and dried to provide membranes C1 and C2 having mass gains of 9.2 and 8.7% respectively, corresponding to graft densities of 0.40 and 0.38 mmol/g.

### Procedure D

Three coating solutions, 20 mL total volume in methanol, were prepared containing 1.0 M AMPS, DEX (140 μL), and sodium salt of 3-carboxybenzophenone (1.0 mL for D1, 0.5 mL for D2, and 0.25 mL for D3, respectively, of a 0.033 g/mL aqueous solution). The solutions were coated onto nylon membrane sheets (8″×8″) and UV grafted by the above UV-Initiated Grafting Procedure for 15 minutes to generate a cation exchange grafted first polymeric block terminated with ethoxythiocarbonylthio groups. After washing with 0.9% saline, methanol, 0.9% saline, methanol (2 more times), 30 minutes each, and drying the sheets, mass gains were measured to determine graft density. The graft densities of D1, D2, and D3 were 0.16 mmol/g, 0.08 mmol/g, and 0.05 mmol/g respectively.

### Procedure E

A coating solution containing 1% by weight benzophenone and 2.5% by weight methyl ethylxanthoylacetate (MEX) in acetone was prepared by weighing out 1.125 grams MEX and 0.5 grams benzophenone and diluting the mixture to a total of 45 grams with acetone. The solution was coated onto nylon membrane sheets (8″×8″) and UV irradiated by the above UV-Initiated Grafting Procedure for 30 minutes to generate membranes functionalized with ethoxythiocarbonylthio groups. The membranes were washed three times with acetone and dried for subsequent grafting.

### Procedure F

A coating solution, 40 mL total volume in methanol, was prepared containing 0.25M AMPS, DEX (560 uL), and sodium salt sodium salt of 3-carboxybenzophenone (4 mL of a 0.033 g/mL aqueous solution). The solution (about 10 mL) was coated onto nylon blown microfiber web (125 grams per square meter, 13.9% solidity, and 5.9 micrometer effective fiber diameter) sheets (3″×4″) inside of a plastic bag with closure. Two sheets were prepared in separate bags. The coated webs were UV irradiated by the above UV-Initiated Grafting Procedure for 30 minutes to generate nonwovens grafted with polymer derived from AMPS and terminated by ethoxythiocarbonylthio groups. After washing the grafted substrates 3 times with methanol only, 30 minutes each, and drying the webs, mass gains were measured to determine graft density. The graft densities for the first grafted substrates F1 and F2 were 0.70 mmol/g and 0.69 mmol/g, respectively.

### Procedure G

A coating solution, 10 mL total volume in water, was prepared containing 0.375M IEM/Agmatine, EXA (100 uL of a 17.9% aqueous solution), and sodium salt sodium salt of 3-carboxybenzophenone (0.5 mL of a 0.033 g/mL aqueous solution). The solution was coated onto a nylon (Nylon 6) blown microfiber web (125 grams per square meter, 13.9% solidity, and 5.9 micrometer effective fiber diameter) sheet (3″×4″) inside of a plastic bag with closure. The coated web was UV irradiated by the above UV-Initiated Grafting Procedure for 30 minutes to generate nonwoven grafted with polymer derived from IEM/Agmatine and terminated by ethoxythiocarbonylthio groups. After washing the grafted substrate with 0.9% saline (once) and water (twice), 30 minutes each, and drying the web, mass gains were measured to determine graft density. The graft densities for the first grafted substrate G1 was 2.1 mmol/g (85% mass gain).

### Formation of Diblock Copolymer Grafted to Substrates

### Examples 1-16

First grafted substrates prepared by Procedure A above that contained a grafted first polymeric block were coated with various concentrations of poly(ethyleneglycol) diacrylate (PEGDA) in deionized water, then UV grafted for 15 or 30 minutes by the UV-Initiated Grafting Procedure described above to prepare membranes with grafted diblock copolymers (second grafted substrates). Graft densities are listed in Table 2. Protein binding capacities, determined by the procedure above, are listed in Table 3, where the control is the corresponding membrane with only the first polymeric block grafted (i.e., the first grafted substrate).

TABLE 2
Preparation of Examples 1-16 and resulting graft density

| | | Block 2 | | | |
|---|---|---|---|---|---|
| | Block 1 | | PEGDA | PEGDA | Graft |
| | First Grafted | UV | 575 | 302 | density |
| Example | Substrate | (minutes) | (M) | (M) | (mmol/g) |
| 1 | A1 | 30 | 0.1 | | 0.14 |
| 2 | A1 | 30 | 0.25 | | 0.31 |
| 3 | A1 | 30 | 0.75 | | 1.45 |
| 4 | A2 | 30 | 0.1 | | 0.16 |
| 5 | A2 | 30 | 0.25 | | 0.39 |
| 6 | A3 | 30 | 0.1 | | 0.19 |
| 7 | A3 | 30 | 0.25 | | 0.42 |
| 8 | A4 | 15 | | 0.1 | 0.17 |
| 9 | A4 | 15 | 0.1 | | 0.13 |
| 10 | A4 | 15 | 0.2 | | 0.43 |
| 11 | A5 | 15 | | 0.1 | 0.18 |
| 12 | A5 | 15 | 0.1 | | 0.14 |
| 13 | A5 | 15 | 0.2 | | 0.44 |
| 14 | A6 | 15 | | 0.1 | 0.17 |
| 15 | A6 | 15 | 0.1 | | 0.12 |
| 16 | A6 | 15 | 0.2 | | 0.41 |

TABLE 3
Lysozyme and IgG binding to Example 1-16

| | | Lysozyme binding (mg/mL) | | IgG binding (mg/mL) | |
|---|---|---|---|---|---|
| | | Control: | | Control: | |
| | First | First | Second | First | Second |
| Exam- | Grafted | Grafted | Grafted | Grafted | Grafted |
| ple | Substrate | Substrate | Substrate | Substrate | Substrate |
| 1 | A1 | 1 | 2 | 4 | 3 |
| 2 | A1 | 1 | 1 | 4 | 2 |
| 3 | A1 | Over-grafted, not tested | | | |
| 4 | A2 | 15 | 15 | 14 | 7 |
| 5 | A2 | 15 | 11 | 14 | 9 |
| 6 | A3 | 22 | 29 | 25 | 6 |
| 7 | A3 | 22 | 21 | 25 | 6 |
| 8 | A4 | 37 | 46 | 20 | 17 |
| 9 | A4 | 37 | 46 | 20 | 8 |
| 10 | A4 | 37 | 32 | 20 | 4 |
| 11 | A5 | 41 | 44 | 21 | 18 |
| 12 | A5 | 41 | 62 | 21 | 10 |
| 13 | A5 | 41 | 48 | 21 | <LOD |
| 14 | A6 | 34 | 37 | 17 | 12 |
| 15 | A6 | 34 | 48 | 17 | 7 |
| 16 | A6 | 34 | 36 | 17 | <LOD |

<LOD—below limit of detection of NanoDrop instrument

### Evaluation of Example 16: Dynamic Binding Experiments Using 25-mm Filter Housings

Buffered protein solutions were used to perform dynamic binding capacity tests on membrane media, using nominally 25-mm diameter filter acrylic housings, as follows. Discs, 25-mm in diameter, of the functional membrane media were die cut from the dried media samples A6 and Example 16 described above. For each tested medium, five discs of functional membrane media were placed in the bottom of the acrylic filter housing. The acrylic housing was then assembled. The acrylic housing was adapted to provide an edge seal about the periphery of the media by means of an O-ring, defining an effective filtration area (EFA) of 2.84 square centimeters (cm²), such that the challenge fluid would flow into an inlet of the housing, then through the five layers of functional membrane media, then out an outlet of the housing. A vent valve positioned near the fluid inlet enabled venting of the housing of air prior to the test.

Dynamic binding capacities (DBC) were conducted using an AKTA Avant 150 system (Cytiva, Marlborough, MA) according to the manufacturer's instructions. Before each test, the filter housing was first vented and flushed at a flow rate of 1 mL/min with 5 mL of binding buffer, 5 mL of elution buffer, then 10 mL of binding buffer. The binding buffer and elution buffer are identified in Table 4 below. The binding buffer was then changed to the test analyte solution (protein dissolved in the appropriate binding buffer) and the test was commenced at a flow rate of 1 mL/min. During a filter test, the UV absorbance at 280 nm of the effluent increased as the membrane became loaded with protein in the challenge fluid. The filter was loaded until the absorbance reached 10% of the test analyte solution maximum absorbance in the filtrate. Following the loading, the filter was washed with 10 mL of binding buffer to rinse off any unbound protein. Two different elution processes were conducted to elute the bound protein. The first elution process used 10 mL of 100% elution buffer. The second elution process used an elution buffer gradient up to 100% elution buffer over 15 mL along with a 5 mL hold at the end of the gradient (20 mL total elution volume). After the elution, a 10 mL of binding buffer was flushed through the filter.

Cytiva's evaluation software (Unicorn) integrated the peak area of the elution peak and calculated the protein concentration, based on the extinction coefficient of protein, that eluted from the membranes. The dynamic binding capacity was determined by the amount of protein bound per calculated volume of membrane. The filter housing was then washed with 10 mL of binding buffer, 10 mL of elution buffer, and re-equilibrated with 10 mL of binding buffer for the next test. Test analyte solutions, lysozyme at 0.28 mg/mL and monoclonal antibody (mAb; IgG1) at 0.25 mg/mL, were prepared in each of the binding buffers. Buffer solutions used are listed in Table 4.

TABLE 4
Binding and Elution Buffers

| Binding Buffer | Elution Buffer |
|---|---|
| (1) 50 mM HEPES, pH 7, | (1) 50 mM HEPES, 1M |
| 1.1 mS/cm | NaCl, pH 7 |
| (2) 50 mM HEPES, pH 7, | (2) 50 mM HEPES, 1M |
| 3.4 mS/cm | NaCl, pH 7 |
| (3) 20 mM MES, pH 5, | (3) 20 mM MES, 1M |
| 3.4 mS/cm | NaCl, pH 5 |

DBC tests were conducted on membranes A6 and Example 16 in each of the running buffers. Results are listed in Table 5.

TABLE 5
DBC Test Results for Example 16

| | | |
|---|---|---|
| Running | Lysozyme DBC (mg/mL) | mAb DBC (mg/mL) |

| Buffer | A6 | Example 16 | A6 | Example 16 |
|---|---|---|---|---|
| 1 | 19.0 | 20.6 | 10.0 | 4.5 |
| 2 | 16.3 | 20.3 | 5.8 | 1.7 |
| 3 | 13.4 | 16.5 | 14.6 | 5.5 |

This Example indicates that addition of the PEGDA block in Example 16 did not impede the binding of lysozyme under flow conditions, but that the binding of a mAb is reduced and can be modulated by adjustment of buffer conditions. Thus, it should be possible to remove a small protein from a large one even though they are of similar charge.

### Examples 17-21

First grafted substrates prepared by Procedure B above were coated with various concentrations of PEG monomers in deionized water, then UV grafted for 15 or 30 minutes by the UV-Initiated Grafting Procedure described above to prepare second grafted substrates, which were membranes with grafted diblock copolymers. Graft densities are listed in Table 6. Protein binding capacities, determined by the procedure above, are listed in Table 7, where the control is the first grafted substrate, which is the membrane with a grafted first polymeric block.

TABLE 6
Preparation of Examples 17-21 and resulting graft density

| | Block 1 | Block 2 | | | | | |
|---|---|---|---|---|---|---|---|
| | First | UV | PEGDA | SR | SR | SR | Graft |
| | Grafted | (min- | 600 | 9035 | 9038 | 415 | density |
| Example | Substrate | utes) | (M) | (M) | (M) | (M) | (mmol/g) |
| 17 | B1 | 15 | 0.1 | | | | 0.18 |
| 18 | B1 | 15 | 0.2 | | | | 0.38 |
| 19 | B2 | 30 | | 0.1 | | | 0.20 |
| 20 | B2 | 30 | | | 0.1 | | 0.11 |
| 21 | B2 | 30 | | | | 0.1 | 0.17 |

TABLE 7
Lysozyme and IgG binding to Example 17-21

| | | Lysozyme binding (mg/mL) | | IgG binding (mg/mL) | |
|---|---|---|---|---|---|
| | | Control: | | Control: | |
| | First | First | Second | First | Second |
| Exam- | Grafted | Grafted | Grafted | Grafted | Grafted |
| ple | Substrate | Substrate | Substrate | Substrate | Substrate |
| 17 | B1 | 28 | 8 | 14 | <LOD |
| 18 | B1 | 28 | 19 | 14 | <LOD |
| 19 | B2 | 26 | 18 | 15 | <LOD |
| 20 | B2 | 26 | 16 | 15 | <LOD |
| 21 | B2 | 26 | 22 | 15 | <LOD |

These examples illustrate that a wide variety of multifunctional PEG monomers provide good protein selectivity.

### Examples 22-25

Sections of the first grafted substrate C1 were coated with various molar ratios of PEG 575 and HEMA monomers, 0.1 M total monomer concentration, in deionized water, then UV grafted for 30 minutes by the UV-Initiated Grafting Procedure described above to prepare membranes with a grafted diblock copolymer. Mass gains are listed in Table 6. Protein binding capacities, determined by the procedure above, are listed in Table 8, where the control is the first grafted substrate.

TABLE 8
Lysozyme and IgG binding to Example
22-24 and Comparative Example 25

| | | | Lysozyme binding | | IgG binding | |
|---|---|---|---|---|---|---|
| | | | (mg/mL) | | (mg/mL) | |
| | PEGDA/ | | Control: | Second | Control: | |
| | HEMA | Mass | First | Grafted | First | Second |
| Exam- | molar | gain | Grafted | Sub- | Grafted | Grafted |
| ple | ratio | (%) | Substrate | strate | Substrate | Substrate |
| 22 | 100:0 | 10.7 | 29 | 33 | 15 | 7 |
| 23 | 50:50 | 5.8 | 29 | 34 | 15 | 8 |
| 24 | 10:90 | 3.7 | 29 | 25 | 15 | 13 |
| CE 25 | 0:100 | 3.4 | 29 | 25 | 15 | 15 |

These examples illustrate that selectivity for proteins can be modulated by inclusion of a small comonomer, and that a block of 100% small comonomer (CE 25) does not provide selectivity.

### Examples 26-28

Sections of first grafted substate D1 were coated with various concentrations of PEGMA 2000 or PEGMA 2000 plus MBA in deionized water, grafted by UV irradiation for 15 minutes, washed three times with deionized water, and dried. Although graft densities were quite low, IgG binding capacities, determined by the procedure above, are listed in Table 9, where the control is the first grafted substrate.

TABLE 9
Lysozyme and IgG binding to Example 26-28

| | | | IgG binding (mg/mL) | |
|---|---|---|---|---|
| | PEGMA 2000 | MBA | Control: First | Second Grafted |
| Example | (M) | (M) | Grafted Substrate | Substrate |
| 26 | 0.1 | 0 | 13 | 9 |
| 27 | 0.25 | 0 | 13 | 8 |
| 28 | 0.1 | 0.1 | 13 | 7 |

These examples illustrate that a monofunctional PEG provides some reduction in binding capacity for a large protein like IgG, and that inclusion of a crosslinker improves that reduction.

### Examples 29-31

Sections of first grafted substrate A2 were UV grafted for 30 minutes with PEGDA 575 or PEGDA 575 plus additional crosslinker MBA or AOHPMA. Compositions of the coating solutions, mass gains, and protein binding are listed in Table 10, where the control is the membrane with only the first polymeric block grafted.

TABLE 10
Lysozyme and IgG binding to Example 29-31

| | | | | | Lysozyme binding | | IgG binding | |
|---|---|---|---|---|---|---|---|---|
| | | | | | (mg/mL) | | (mg/mL) | |
| | | | | | Control: | | Control: | |
| | PEGDA | | | Mass | First | Second | First | Second |
| | 575 | MBA | AOHPMA | gain | Grafted | Grafted | Grafted | Grafted |
| Example | (M) | (M) | (M) | (%) | Substrate | Substrate | Substrate | Substrate |
| 29 | 0.1 | 0 | 0 | 8.9 | 15 | 15 | 12 | 6 |
| 30 | 0.1 | 0.03 | 0 | 6.4 | 15 | 11 | 12 | 4 |
| 31 | 0.1 | 0 | 0.03 | 11.1 | 15 | 10 | 12 | 4 |

These examples illustrate that the addition of short chain crosslinkers can modulate the protein selectivity.

### Examples 32-34

Sections of first grafted substrate C2 were UV grafted for 30 minutes with various concentrations of high molecular weight PEGDA monomers in deionized water. Membranes were washed 3 times with deionized water and dried. Table 11 lists monomers, concentrations, mass gains, and protein binding capacities.

TABLE 11
Lysozyme and IgG binding to Example 32-34

| | | | Lysozyme binding | | IgG binding | |
|---|---|---|---|---|---|---|
| | | | (mg/mL) | | (mg/mL) | |
| | | | Control: | | Control: | |
| | | Mass | First | Second | First | Second |
| | PEGDA | gain | Grafted | Grafted | Grafted | Grafted |
| Example | (M) | (%) | Substrate | Substrate | Substrate | Substrate |
| 32 | PEGDA 2000 | 2.3 | 29 | 32 | 15 | 8 |
| | (0.025) | | | | | |
| 33 | PEGDA 6000 | 1.4 | 29 | 29 | 15 | 7 |
| | (0.01) | | | | | |
| 34 | PEGDA 10000 | 0.3 | 29 | 29 | 15 | 10 |
| | (0.003) | | | | | |

### Examples 35-36

Coating solutions were prepared by mixing MAPTAC solution (50% wt/wt in water), 2.324 mL for Example 35 and 2.905 mL for Example 36, with 0.5 mL of 3-carboxybenzophenone, sodium salt solution (0.033 g/mL aqueous solution) and 35 μL of diethylbisxanthate and diluting the mixtures to a total of 5 mL with methanol. This provided solutions that were 1.0 and 1.25 M in MAPTAC, respectively. These solutions were coated on nylon membranes, UV grafted for 30 minutes, washed three times with methanol, and dried to generate membranes having an anion exchange first polymeric block (first grafted substrate) terminated with ethoxythiocarbonylthio groups with graft densities of 0.25 and 0.78 mmol/g, respectively. Subsequently, each membrane was grafted with 0.1 M PEGDA 575 in deionized water, 30 minutes UV, washed and dried to give membranes having a second polymeric block (second grafted substrates) with 10.5 and 10.8% mass gains, respectively.

These membranes were tested for binding capacity for β-lactoglobulin (a 3.5 nm diameter protein), bovine serum albumin (BSA, a 7.1 nm diameter protein), and phi6 (a 75-85 nm diameter bacteriophage). Binding buffer for the proteins was 50 mM HEPES, pH 7, and for phi6 was 25 mM Tris, pH 8. Results are listed in Table 12 as the % reduction in binding of the block copolymer membrane vs the MAPTAC only control. % Reduction is calculated as: 100-100 (binding by block copolymer/binding by control).

TABLE 12
Evaluation of Examples 35-36

| | % Reduction | | |
|---|---|---|---|
| Example | β-lactoglobulin | BSA | phi6 |
| 35 | 15 | 27 | Not tested |
| 36 | 21 | 39 | 93 |

These experiments indicate that it should be possible to capture host cell protein impurities present in a clarified cell culture while a virus or virus-like particle would flow through and be purified.

### Example 37-39

A 6″×8″ functionalized membrane prepared by Procedure E above was coated with IEM/agmatine (0.2 M in deionized water) and UV grafted for 30 minutes by the UV-Initiated Grafting Procedure described above to generate a membrane having an anion exchange first polymeric block terminated with ethoxythiocarbonylthio groups with a ligand density of 0.29 mmol/g. The membranes were cut into 4 pieces, three of which were coated with PEGDA 575 in deionized water, 30 minutes UV, washed and dried to provide membranes with a second polymer block. The membranes were tested for protein binding capacities for β-lactoglobulin and BSA. Results are listed in Table 13.

TABLE 13
β-Lactoglobulin and BSA binding to Example 37-39

| | | | β-Lactoglobulin binding (mg/mL) | | | BSA binding (mg/mL) | | |
|---|---|---|---|---|---|---|---|---|
| | | | Control: | | | Control: | | |
| | PEGDA | Mass | First | Second | | First | Second | |
| | 575 | gain | Grafted | Grafted | % | Grafted | Grafted | % |
| Example | (M) | (%) | Substrate | Substrate | Reduction | Substrate | Substrate | Reduction |
| 37 | 0.1 | 4.9 | 52 | 51 | 2 | 41 | 42 | 0 |
| 38 | 0.2 | 15.5 | 52 | 47 | 10 | 41 | 33 | 21 |
| 39 | 0.3 | 26.5 | 52 | 27 | 49 | 41 | 18 | 56 |

These experiments indicate that optimization of the mass gain for second polymeric block can be important. If too little is grafted, no discrimination is observed; if too much is grafted, the smaller protein begins to be excluded almost as much as the larger one; when the right amount is grafted, reduced binding of the large protein is observed with minimal effect on the smaller protein.

### Examples 40-42

A 6″×8″ functionalized membrane prepared by Procedure E above was coated with IEM/GABA (0.5 M in deionized water) and UV grafted for 30 minutes by the UV-Initiated Grafting Procedure described above to generate a membrane having a cation exchange first polymeric block (first grafted substrate) terminated with ethoxythiocarbonylthio groups with a ligand density of 0.33 mmol/g. A second polymeric block was grafted using various concentrations of PEGDA 575 in deionized water and in the presence or absence of added water-soluble xanthate, EXA, 15 minutes UV grafting time. Results are shown in Table 14.

TABLE 14
Evaluation of Examples 40-42

| Example | PEGDA 575 (M) | EXA (M) | Mass gain (%) |
|---|---|---|---|
| 40 | 0.1 | 0 | 0.6 |
| 41 | 0.2 | 0 | 1.3 |
| 42 | 0.2 | 0.004 | 3.4 |

### Examples 43-45

A 6″×8″ functionalized membrane prepared by Procedure E above was coated with IEM/GABA (0.7 M plus 0.004 M EXA in deionized water) and UV grafted for 30 minutes by the UV-Initiated Grafting Procedure described above to generate a membrane having a cation exchange first polymeric block (first grafted substrate) terminated with ethoxythiocarbonylthio groups with a ligand density of 0.61 mmol/g. A second polymeric block was grafted using various concentrations of PEGDA 575 in deionized water and in the presence or absence of added water-soluble xanthate, EXA, 30 minutes UV grafting time. Protein binding capacities for lysozyme and IgG were measured. Results are shown in Table 15.

TABLE 15
Lysozyme and IgG binding to Example 43-45

| | | | | Lysozyme binding | | IgG binding | |
|---|---|---|---|---|---|---|---|
| | | | | (mg/mL) | | (mg/mL) | |
| | | | | Control: | | Control - | |
| | PEGDA | | Mass | First | Second | First | Second |
| | 575 | EXA | gain | Grafted | Grafted | Grafted | Grafted |
| Example | (M) | (M) | (%) | Substrate | Substrate | Substrate | Substrate |
| 43 | 0.1 | 0 | 6.9 | 111 | 109 | 167 | 127 |
| 44 | 0.2 | 0 | 10.8 | 111 | 110 | 167 | 86 |
| 45 | 0.3 | 0.004 | 16.3 | 111 | 106 | 167 | 82 |

These examples show that IgG binding can be reduced by proper adjustment of the second polymeric block without any effect on lysozyme binding.

### Examples 46-47

Polyethersulfone membrane substrates (MicroPES 8F, nominal pore size 0.8 μm, obtained from 3M Separation and Purification Sciences, St. Paul, MN) were grafted (15 minutes UV) with VDM/GABA at 0.2 and 0.4 M monomer concentrations in deionized water. The grafting solutions also contained 0.004 and 0.008 M EXA, respectively. This resulted in a first carboxylate-functional block (first grafted substrate) terminated with thiocarbonylthio groups. After washing and drying, a second polymeric block was added to the membranes by grafting with PEG 575 at 0.2 M concentration in deionized water, 30 minutes UV irradiation time to form the second grafted substrate. The first and second grafted substrates were tested for lysozyme and IgG binding capacities. Results are listed in Table 16 as the % reduction in binding of the block copolymer membrane vs the VDM/GABA only control.

TABLE 16
Lysozyme and IgG binding to Example 46-47

| | |
|---|---|
| Mass gain (%) | % Reduction |

| Example | Block 1 | Block 2 | Lysozyme | IgG |
|---|---|---|---|---|
| 46 | 0.4 | 28.5 | 49 | 74 |
| 47 | 2.3 | 26.9 | 58 | 78 |

These examples indicate that the block copolymer is selective for the smaller protein, lysozyme, over the larger protein, IgG. Optimization of the grafting process could improve the selectivity.

### Examples 48-50

A 6″×8″ functionalized membrane prepared by Procedure E above was coated with IEM/Glycine (0.5 M plus 0.004 M EXA in deionized water) and UV grafted for 30 minutes by the UV-Initiated Grafting Procedure described above to generate a membrane having a cation exchange first polymeric block terminated (first grafted substrate) by ethoxythiocarbonylthio groups with a ligand density of 0.41 mmol/g. A second polymeric block was grafted using various PEG monomethacrylates, PEGMA 200, PEGMA 400, and PEGMA 2000, respectively, in deionized water, 30 minutes UV grafting time. Protein binding capacities for lysozyme and IgG were measured. Results are shown in Table 17.

TABLE 17
Lysozyme and IgG binding to Example 48-50

| | | | Lysozyme binding | | IgG binding | |
|---|---|---|---|---|---|---|
| | | | (mg/mL) | | (mg/mL) | |
| | | | Control: | Second | Control: | |
| | | Mass | First | Grafted | First | Second |
| Exam- | PEGMA | gain | Grafted | Sub- | Grafted | Grafted |
| ple | (M) | (%) | Substrate | strate | Substrate | Substrate |
| 48 | 0.5 | 19.8 | 51 | 58 | 128 | 97 |
| 49 | 0.3 | 12.9 | 51 | 58 | 128 | 95 |
| 50 | 0.25 | 1.9 | 51 | 56 | 128 | 113 |

These examples show that IgG binding can be reduced by a second polymeric block of PEG mono-methacrylate, probably by steric exclusion, without any loss in lysozyme binding.

### Example 51

First grafted substate F2 prepared by Procedure F above was coated with 0.1M PEGDA in deionized water (10 mL) inside of a plastic bag with closure and UV grafted for 30 minutes by the UV-Initiated Grafting Procedure described above. The web was washed once with 0.9% saline, twice with deionized water (30 minutes each), and then dried. Measured graft density of the second polymeric block was: F3—0.13 mmol/g. Thickness was measured after drying and determined to be 0.79 mm. Protein binding capacities, determined by the procedure above, were determined with the following modification and listed in Table 18 below: 3 mg/mL lysozyme in 50 mM HEPES buffer, pH 7 used instead of 3.5 mg/mL lysozyme in 10 mM MOPS buffer, pH 7.

TABLE 18
Lysozyme and IgG binding to Example 51

| | | Lysozyme binding (mg/mL) | | IgG binding (mg/mL) | |
|---|---|---|---|---|---|
| | First | First | Second | First | Second |
| | Grafted | Grafted | Grafted | Grafted | Grafted |
| Exam- | Substrate | Substrate | Substrate | Substrate | Substrate |
| ple | (AMPS) | (F1) | (F3) | (F1) | (F3) |
| 51 | F | 7.4 | 7.3 | 8.3 | 6.1 |

This example illustrates no reduction in lysozyme binding but some reduction in the binding of the larger protein, IgG, for a block copolymer grafted to a nonwoven substrate.

### Example 52

First grafted substate G1 prepared by Procedure G above was cut in half (2 inch×3 inch) and one piece was coated with 0.15M PEGDA with EXA (50 uL of a 17.9% aqueous solution) in deionized water (5 mL) inside of a plastic bag with closure. The coated nonwoven sheet was UV grafted for 30 minutes by the UV-Initiated Grafting Procedure described above. The nonwoven sheets G1 and G2 were both washed once with 0.9% saline, twice with deionized water (30 minutes each), and then dried. Measured graft density of the second polymeric block was: G2-0.42 mmol/g. Thickness was measured after drying and determined to be 0.79 mm.

Protein binding capacities were determined with a modified protocol than the one described above. Three disks of each G1 and G2 were prepared by die-punching an 18-mm diameter disk from a sheet of the substrate. Each disk was placed in a 5 mL centrifuge tube with 4.5 mL of 5 mg/mL BSA in 25 mM Tris-HCl with 100 mM NaCl at pH 7.6. The tubes were capped and tumbled overnight. The supernatant solutions were discarded, the tubes were filled with 25 mM Tris-HCl with 100 mM NaCl at pH 7.6 and tumbled for 15-30 minutes to wash off excess protein solution. The supernatant solutions were discarded, and the buffer wash was repeated two more times. Bound BSA was eluted by adding 3 mL of 25 mM Tris-HCl with 1M NaCl at pH 7.6 and tumbling for 30 minutes. Protein concentrations in the eluates were analyzed using a NANODROP UV-VIS Spectrophotometer. The eluate solutions were discarded, and then stripped with another 3 mL 25 mM Tris-HCl with 1M NaCl at pH 7.6 for 30 min while tumbling. The strip solution was discarded, the tubes were filled with 25 mM Tris-HCl with 100 mM NaCl at pH 7.6 and tumbled for 15-30 minutes to wash and equilibrate the disks. The supernatant solutions were discarded, and the buffer wash was repeated two more times. Excess solution in the disk was gently squeezed out and discarded. To the 5 mL tubes with the washed disks of G1 and G2, 4.5 mL of 5 mg/mL beta-lactoglobulin in 25 mM Tris-HCl with 100 mM NaCl at pH 7.6 was added to each tube. The tubes were capped and tumbled overnight. The supernatant solutions were discarded, the tubes were filled with 25 mM Tris-HCl with 100 mM NaCl at pH 7.6 and tumbled for 15-30 minutes to wash off excess protein solution. The supernatant solutions were discarded, and the buffer wash was repeated two more times. Bound β-Lactoglobulin was eluted by adding 3 mL of 25 mM Tris-HCl with 1M NaCl at pH 7.6 and tumbling for 30 minutes. Protein concentrations in the eluates were analyzed using a NANODROP UV-VIS Spectrophotometer. The binding capacity for each substrate was determined from the UV absorbance and the protein extinction coefficient provided by the supplier. Results are reported in mg/mL (mg of protein bound/mL of nonwoven volume) as the average of three replicates.

TABLE 19
B-Lactoglobulin and BSA binding to Example 52

| | | β-Lactoglobulin | | | |
|---|---|---|---|---|---|
| | First | binding (mg/mL) | | BSA binding (mg/mL) | |
| | Grafted | First | Second | First | Second |
| | Substrate | Grafted | Grafted | Grafted | Grafted |
| Exam- | (IEM/ | Substrate | Substrate | Substrate | Substrate |
| ple | Agmatine) | (G1) | (G2) | (G1) | (G2) |
| 52 | G | 45.6 | 46.8 | 63.8 | 34.2 |

This example illustrates no reduction in β-Lactoglobulin binding and a reduction in a larger protein, BSA, for a block copolymer grafted to a nonwoven substrate.

### Examples 53-54

A coating solution, 20 mL total volume, was prepared containing 1.5M AMPS and the sodium salt of 3-carboxybenzophenone (Aldrich Chemical, Milwaukee, WI) (2.0 mL of a 0.033 g/mL aqueous solution) in methanol. The solution was coated onto a nylon membrane sheet (8″×8″) and UV grafted by the above UV-Initiated Grafting Procedure for 15 minutes to generate a grafted cation exchange first polymeric block derived from AMPS and terminated with semi-pinacol-containing groups. After washing with 0.9% saline, methanol, 0.9% saline, methanol (2 more times), 30 minutes each, and drying the sheet, mass gain was measured to a determine graft density of 1.25 mmol/g. Portions of this first grafted substrate were coated with 0.1 M (Example 53) or 0.2 M (Example 54) concentrations of poly(ethyleneglycol) diacrylate (PEGDA 575) in deionized water, then UV grafted for 15 minutes by the UV-Initiated Grafting Procedure described above to prepare membrane Examples 53 and 54, with grafted diblock copolymers (second grafted substrates). Graft densities for these second grafted substrates were 0.22 and 0.40 mmol/g, respectively. Protein binding capacities, determined by the procedure above, are listed in Table 20, where the control is the corresponding membrane with only the first polymeric block grafted (i.e., the first grafted substrate).

TABLE 20
Lysozyme and IgG binding to Example 53-54

| | Lysozyme binding (mg/mL) | | IgG binding (mg/mL) | |
|---|---|---|---|---|
| | Control: First | Second | Control: First | Second |
| | Grafted | Grafted | Grafted | Grafted |
| Example | Substrate | Substrate | Substrate | Substrate |
| 53 | 84 | 154 | 89 | 55 |
| 54 | 84 | 111 | 89 | 45 |

### Examples 55-56

A first grafted substrate was prepared by a procedure similar to that above for Examples 53-54, except that the AMPS concentration was 0.75 M, resulting in a grafted nylon membrane having a graft density of 0.54 mmol/g, and at least some of the grafted chains terminated with semi-pinacol groups. Portions of this first grafted substrate were coated with 0.1 M (Example 55) or 0.2 M (Example 56) concentrations of poly(ethyleneglycol) diacrylate (PEGDA 575) in deionized water, then UV grafted for 15 minutes by the UV-Initiated Grafting Procedure described above to prepare membrane Examples 55 and 56, with grafted diblock copolymers (second grafted substrates). Graft densities for these second grafted substrates were 0.17 and 0.39 mmol/g, respectively. Protein binding capacities, determined by the procedure above, are listed in Table 21, where the control is the corresponding membrane with only the first polymeric block grafted (i.e., the first grafted substrate).

TABLE 21
Lysozyme and IgG binding to Example 55-56

| | Lysozyme binding (mg/mL) | | IgG binding (mg/mL) | |
|---|---|---|---|---|
| | Control: First | Second | Control: First | Second |
| | Grafted | Grafted | Grafted | Grafted |
| Example | Substrate | Substrate | Substrate | Substrate |
| 55 | 73 | 70 | 49 | 33 |
| 56 | 73 | 63 | 49 | 22 |

### Examples 57-58

A first grafted substrate was prepared by a procedure similar to that above for Examples 53-54, except that the AMPS concentration was 0.5 M and the Type II photoinitiator was 1.0 mL of sodium carboxybenzophenone initiator solution, resulting in a grafted nylon membrane having an even lower graft density of 0.30 mmol/g, and at least some of the grafted chains terminated with semi-pinacol groups. Portions of this first grafted substrate were coated with 0.1 M (Example 57) or 0.2 M (Example 58) concentrations of poly(ethyleneglycol) diacrylate (PEGDA 575) in deionized water, then UV grafted for 15 minutes by the UV-Initiated Grafting Procedure described above to prepare membrane Examples 57 and 58, with grafted diblock copolymers (second grafted substrates). Graft densities for these second grafted substrates were 0.09 and 0.31 mmol/g, respectively. Protein binding capacities, determined by the procedure above, are listed in Table 22, where the control is the corresponding membrane with only the first polymeric block grafted (i.e., the first grafted substrate).

TABLE 22
Lysozyme and IgG binding to Example 57-58

| | Lysozyme binding (mg/mL) | | IgG binding (mg/mL) | |
|---|---|---|---|---|
| | Control: First | Second | Control: First | Second |
| | Grafted | Grafted | Grafted | Grafted |
| Example | Substrate | Substrate | Substrate | Substrate |
| 57 | 43 | 43 | 30 | 27 |
| 58 | 43 | 28 | 30 | 19 |

### Examples 59-60

A coating solution containing 1% by weight benzophenone in acetone was coated onto nylon membrane sheets (6″×8″) and UV irradiated by the above UV-Initiated Grafting Procedure for 30 minutes to generate membranes functionalized with semi-pinacol-containing groups. The membranes were washed three times with acetone and dried for subsequent grafting. This membrane was coated with IEM/GABA (0.4 M in deionized water) and UV grafted for 30 minutes by the UV-Initiated Grafting Procedure described above to generate a membrane having a cation exchange first polymeric block (first grafted substrate) terminated with semi-pinacol groups with a ligand density of 0.38 mmol/g. A second polymeric block was grafted to portions of this grafted membrane using various concentrations of PEGDA 575 in deionized water, and 30 minutes UV grafting time. Protein binding capacities for lysozyme and IgG were measured. Results are shown in Table 23.

TABLE 23
Lysozyme and IgG binding to Example 59-60

| | | | Lysozyme binding | | IgG binding | |
|---|---|---|---|---|---|---|
| | | | (mg/mL) | | (mg/mL) | |
| | | | Control: | | Control - | |
| | PEGDA | Mass | First | Second | First | Second |
| Exam- | 575 | gain | Grafted | Grafted | Grafted | Grafted |
| ple | (M) | (%) | Substrate | Substrate | Substrate | Substrate |
| 59 | 0.1 | 3.0 | 113 | 114 | 165 | 178 |
| 60 | 0.2 | 7.5 | 113 | 125 | 165 | 143 |

1. A separation article comprising:
a porous polymeric substate that is a solid material; and
a plurality of block copolymeric chains grafted to the solid porous polymeric substrate and extending away from a surface of the solid porous polymeric substrate, wherein the block copolymeric chains comprise
a) a first polymeric block that is covalently attached to the solid porous polymeric substrate, wherein the first polymeric block comprises an acidic monomeric unit comprising an acidic group or a salt thereof, a basic monomeric unit comprising a basic group or a salt thereof, or combination thereof; and
b) a second polymeric block that is covalently bonded to the first polymeric block
with the first polymeric block positioned between the second polymeric block and the solid porous polymeric substrate, wherein the second polymeric block comprises polyether-containing monomeric units.

2. The separation article of claim 1, wherein the first polymeric block is directly and covalently attached to a carbon atom of the solid porous polymeric substrate.

3. The separation article of claim 1, wherein the acid monomer and/or the basic monomer is of Formula (IV) or a salt thereof 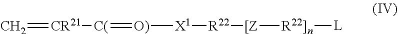
wherein
R²¹ is hydrogen or methyl;
each R²² is independently a (hetero)hydrocarbylene;
X¹ is —O— or —NR²³— where R²³ is hydrogen or hydrocarbyl;
Z is heterohydrocarbylene comprising at least one hydrogen bond donor, at least one hydrogen bond acceptor, or a combination thereof;
n is an integer of 0 or 1; and
L is a ligand functional group that is an acidic group, a basic group, or salt thereof.

4. The separation article claim 1, wherein the porous polymeric substrate comprises particles, fibers, films, a non-woven web, a membrane, a sponge, or a sheet.

5. The separation article of claim 4, wherein the porous polymeric substrate comprises a non-woven web or a membrane.

6. The separation article of claim 1, wherein the second polymeric block is hydrophilic or water swellable.

7. A method of making a separation article comprising a solid porous polymeric substrate and a plurality of block copolymers grafted to the solid polymeric substrate and extending away from a surface of the solid porous polymeric substrate, the method comprising:
providing the solid porous polymeric substrate; and
grafting a plurality of first polymeric blocks to the solid porous polymeric substrate using a reversible deactivation radical polymerization process, wherein the first polymeric blocks are covalently bonded to the solid porous polymeric substrate, and wherein the first polymeric blocks are a reaction product of a first polymerizable composition comprising
1) an acidic monomer comprising an ethylenically unsaturated group and an acid group or salt thereof; and/or
2) a basic monomer comprising an ethylenically unsaturated group and a basic group or salt thereof; and
forming a plurality of second polymeric blocks, wherein the second polymeric blocks are covalently bonded to the first polymeric blocks using the reversible deactivation radical polymerization process, wherein the first polymeric blocks are positioned between the solid porous polymeric substrate and the second polymeric blocks, and wherein the second polymeric blocks are a reaction product of a second polymerizable composition comprising
1) a polyether monomer comprising at least one ethylenically unsaturated group and a polyether group.

8. The method of claim 7, wherein the reversible deactivation radical polymerization process is a reversible addition-fragmentation chain transfer polymerization process.

9. The method of claim 7, wherein the reversible deactivation radical polymerization process comprises using a thiocarbonylthio-containing compound as a polymerization control agent.

10. The method of claim 7, wherein the thiocarbonylthio-containing compound has a thiocarbonylthio-containing group of formula —S—C(═S)—R¹ and wherein
R¹ is an alkoxy, aralkyloxy, alkenyloxy or —N(R⁴)₂; and
each R⁴ is an alkyl or two adjacent R⁴ groups are combined with the nitrogen to which they are both attached to form a first heterocyclic ring having 1 to 3 heteroatoms selected from nitrogen, oxygen, and sulfur, the first heterocyclic ring being saturated or unsaturated and optionally fused to one or more second rings that are carbocyclic or heterocyclic.

11. The method of claim 7, wherein the block copolymers are directly and covalently bonded to a carbon atom of the solid porous polymeric substrate.

12. The method of claim 7, wherein the first polymeric block has a terminal thiocarbonylthio-containing group or a semi-pinacol group prior to forming the second polymeric block.

13. A method of separating a mixture of materials of different size and of optionally different ionic content, the method comprising:
preparing or providing a separation article comprising a solid porous polymeric substrate and a plurality of block copolymers grafted to the solid porous polymeric substrate using a reversible deactivation radical polymerization process, wherein the block copolymers extend away from a surface of the solid porous polymeric substrate and comprise
a) a first polymeric block covalently attached to the porous polymeric substate, the first polymeric block comprising first monomeric units having a binding group that is an acid group, a basic group, or salt thereof for interacting with a material having a complementary group; and
b) a second polymeric block covalently bonded to the first polymeric block with the first polymeric block positioned between the second polymeric block and the solid porous polymeric substrate, wherein the second polymeric block comprises polyether-containing monomeric units; and
passing the mixture of materials through the separation article, wherein the second polymeric block separates the mixture of materials based on size or steric exclusion and allows only a portion of the materials to contact the acid groups, basic groups, or salts thereof of the first polymeric block.

14. The method of claim 13, wherein the mixture of materials comprises biomaterials.
